(19) United States
(12) Patent Application Publication
(10) Pub. No.: US 2017/0063647 A1
(43) Pub. Date: Mar. 2, 2017

(54) MANAGEMENT DEVICE AND MANAGEMENT METHOD

(71) Applicant: FUJITSU LIMITED, Kawasaki-shi (JP)

(72) Inventor: Hiroshi Otsuka, Inagi (JP)

(73) Assignee: FUJITSU LIMITED, Kawasaki-shi (JP)

(21) Appl. No.: 15/232,843

(22) Filed: Aug. 10, 2016

(30) Foreign Application Priority Data
Aug. 31, 2015 (JP) 2015-170294

(51) Int. Cl. H04L 12/24; H04L 12/931; H04L 12/14

(52) U.S. Cl. CPC H04L 41/5051; H04L 41/082; H04L 12/1403; H04L 49/357

(57) ABSTRACT

A management device that manages permitting a first device to use a license, the management device includes a memory configured to store management information including information regarding a license of which renting out and borrowing is performed between the first device and a second device included in a plurality of connection destination devices coupled to the first device through a network and information regarding the license for the first device, and a processor configured to update the management information based on connection information for the second device when the connection state of the second device is changed.

### CROSS-REFERENCE TO RELATED APPLICATION

This application is based upon and claims the benefit of priority of the prior Japanese Patent Application No. 2015-170294 filed on Aug. 31, 2015, the entire contents of which are incorporated herein by reference.

### FIELD

The embodiment discussed herein is related to a management device and a management method.

### BACKGROUND

A service provider (hereinafter, also simply referred to as a provider) who provides a user with a service constructs, for example, a business system according to purpose of use and operates the business system in order to provide the user with various services.

The provider uses, for example, a plurality of physical machines on which an application for providing the user with a service runs and a plurality of storage devices that store data accessed when the application performs processing to thereby construct the business system as described above.

The provider constructs the business system, for example, in such a way that a data transfer either between a physical machine and a storage or between a plurality of storages is performed through relay devices such as a plurality of switches (for example, fiber channel switches or the like). With this, the provider is able to construct a business system having a configuration in which a specific storage device is shared by a plurality of physical machines or a specific physical machine uses a plurality of storage devices. Thus, the provider is able to efficiently perform the data transfer either between the physical machine and the storage or between the plurality of storages.

Examples of related art include, for example, Japanese Laid-open Patent Publication No. 2013-047900 and Japanese Laid-open Patent Publication No. 2006-085484.

In the business system as described above, there may be a case where the provider applies a license in order to perform adding of a function to a network apparatus such as a relay device. For example, in a case where an unused port is desired to be newly used, the provider purchases a port on demand (POD) license and applies the POD license on the port in order to make it possible for the unused port to be used.

The POD license as described above is generally applied to each network apparatus such as a switch. Thus, a license purchased for a certain network apparatus may not be used for other network apparatuses, for example, even in a case where a plurality of network apparatuses operate in the business system. Accordingly, in a case where a change is made in a configuration of the business system, the provider may not efficiently utilize the license purchased for respective network apparatuses included in the business system.

### SUMMARY

According to an aspect of the invention, a management device that manages permitting a first device to use a license, the management device includes a memory configured to store management information including information regarding a license of which renting out and borrowing is performed between the first device and a second device included in a plurality of connection destination devices coupled to the first device through a network and information regarding the license for the first device, and a processor configured to update the management information based on connection information for the second device when the connection state of the second device is changed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the entire configuration of a network apparatus group;

FIG. 2 is a diagram illustrating a comparative example of the network apparatus group of FIG. 1;

FIG. 3 is a diagram illustrating an example of license information;

FIG. 4 is a diagram illustrating a hardware configuration of a network apparatus;

FIG. 5 is a functional block diagram of the network apparatus of FIG. 4;

FIG. 6 is a flowchart illustrating an outline of a license management process in a first embodiment;

FIG. 7 is a diagram illustrating the outline of the license management process in the first embodiment;

FIG. 8 is a diagram illustrating the outline of the license management process in the first embodiment;

FIG. 9 is a flowchart illustrating a license renting-out process in the first embodiment;

FIG. 10 is a flowchart illustrating a license renting-out process in the first embodiment;

FIG. 11 is a flowchart illustrating a license renting-out end process in the first embodiment;

FIG. 12 is a flowchart illustrating a license renting-out end process in the first embodiment;

FIG. 13 is a flowchart illustrating a disconnection detection process in the first embodiment;

FIG. 14 is a flowchart illustrating a connection detection process in the first embodiment;

FIG. 15 is a flowchart illustrating a connection detection process in the first embodiment;

FIG. 16 is a flowchart illustrating a connection detection process in the first embodiment;

FIG. 17 is a flowchart illustrating a connection detection process in the first embodiment;

FIG. 18 is a flowchart illustrating a connection detection process in the first embodiment;

FIG. 19 is a diagram illustrating an example of a renting-out frame;

FIG. 20 is a diagram illustrating an example of a renting-out response frame;

FIG. 21A and FIG. 21B are diagrams illustrating an example of management information and another management information before processing of S14 and S22 is executed;

FIG. 22A and FIG. 22B are diagrams illustrating an example of the management information and the other management information after the processing of S14 and S22 is executed;

FIG. 23 is a diagram illustrating an example of a renting-out end frame;

FIG. 24A and FIG. 24B are diagrams illustrating an example of the management information and the other management information after processing of S35 and S43 is executed;

FIG. 25A and FIG. 25B are diagrams illustrating an example of the management information and the other management information after processing of S53 and S55 is executed;

FIG. 26 is a diagram illustrating an example of a use permission frame;

FIG. 27 is a diagram illustrating an example of a domain ID request frame;

FIG. 28A and FIG. 28B are diagrams illustrating an example of the management information and the other management information after processing of S75 and S102 (processing of S83 and S113) is executed;

FIG. 29 is a diagram illustrating an example of corresponding information before processing of S75 is executed;

FIG. 30 is a diagram illustrating an example of the corresponding information after the processing of S75 is executed;

FIG. 31 is a diagram illustrating an example of the corresponding information after processing of S84 is executed;

FIG. 32A and FIG. 32B are diagrams illustrating details of processing of S63; and

FIG. 33A and FIG. 33B are diagrams illustrating details of processing of S63.

### DESCRIPTION OF EMBODIMENT

One aspect of an embodiment of the present disclosure is to provide a management device which is able to cause a license to be shared among management target devices that are coupled to a network and to manage the shared license and a license management program.

Configuration of Network Apparatus Group

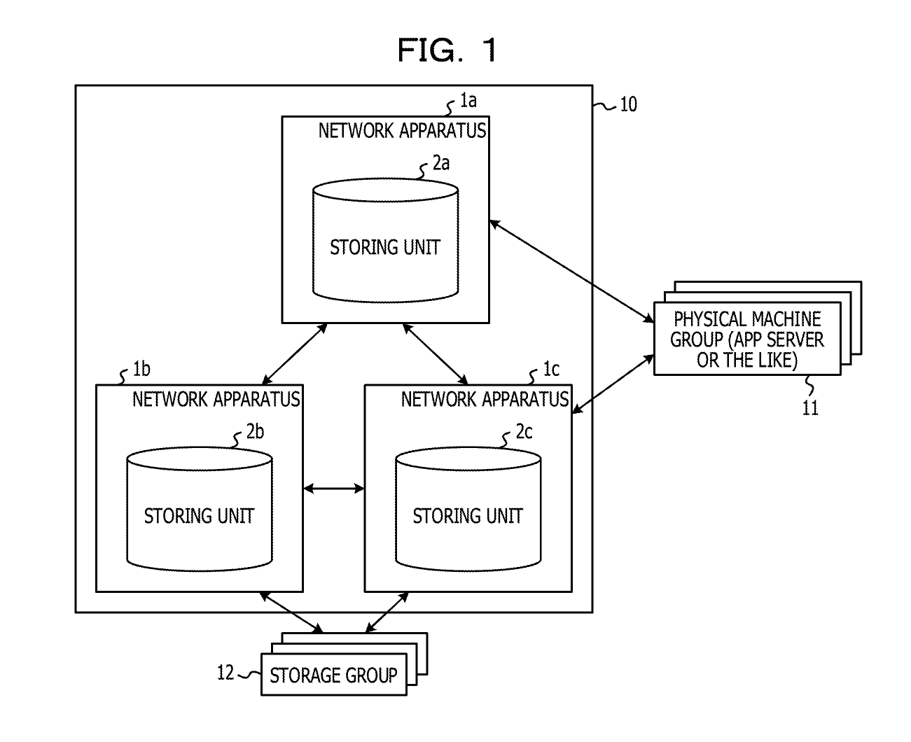

FIG. 1 is a diagram illustrating the entire configuration of a network apparatus group 10. The network apparatus group 10 illustrated in FIG. 1 includes a network apparatus 1a (hereinafter, also referred to as a management target device 1a), a network apparatus 1b, and a network apparatus 1c (hereinafter, also referred to as a management target device 1b and a management target device c, respectively). Hereinafter, the network apparatus 1a is also referred to as a first device 1a and the network apparatus 1b and the network apparatus 1c are also referred to as the second devices 1b and 1c, respectively.

The network apparatus group 10 is, for example, a fabric 10 configured by interconnecting a plurality of network apparatuses (for example, fiber channel switches). In particular, the fiber channel switches may constitute a storage area network (SAN) fabric. Domain IDs of respective fiber channel switches within the fabric are ensured to be unique. Thus, it is possible to recognize the existence of other fiber channel switches constituting the same fabric. Hereinafter, description is made by regarding each network apparatus included in the network apparatus group 10 as the fiber channel switch.

In the network apparatus group 10 illustrated in FIG. 1, the network apparatus 1a and the network apparatus 1c are connected to a physical machine group 11 which functions as an application server (hereinafter, also referred to as APP server) or the like on which an application for providing a user with a service runs. In the network apparatus group 10 illustrated in FIG. 1, the network apparatus 1b and the network apparatus 1c are connected to a storage group 12 which stores data accessed by the physical machine group 11.

That is, in the network apparatus group 10 illustrated in FIG. 1, the physical machine group 11 accesses the storage group 12 through the network apparatus group 10. With this, unlike a case where physical machines included in the physical machine group 11 and storages included in the storage group 12 are directly connected with each other, each physical machine included in the physical machine group 11 is able to access respective storages included in the storage group 12. Thus, the plurality of physical machines included in the physical machine group 11 are able to use, for example, a specific storage included in the storage group 12 to be shared. A specific physical machine included in the physical machine group 11 is able to use, for example, the plurality of storages included in the storage group 12.

In the network apparatus group 10 illustrated in FIG. 1, the network apparatus 1a includes a storing unit 2a, the network apparatus 1b includes a storing unit 2b, and the network apparatus 1c includes a storing unit 2c.

A network apparatus, for example, a server, a storage device, or the like, which is able to uniquely recognize other network apparatuses connected to a network may be used as management target devices 1a, 1b and is without being limited to a relay device such as a router or a switch or the like. Hereinafter, although description is made on a case where the network apparatus group 10 includes the network apparatus 1a, the network apparatus 1b, and the network apparatus 1c, the network apparatus group 10 may have a configuration provided with a single, two, or four or more network apparatuses.

Comparative Example of Network Apparatus Group

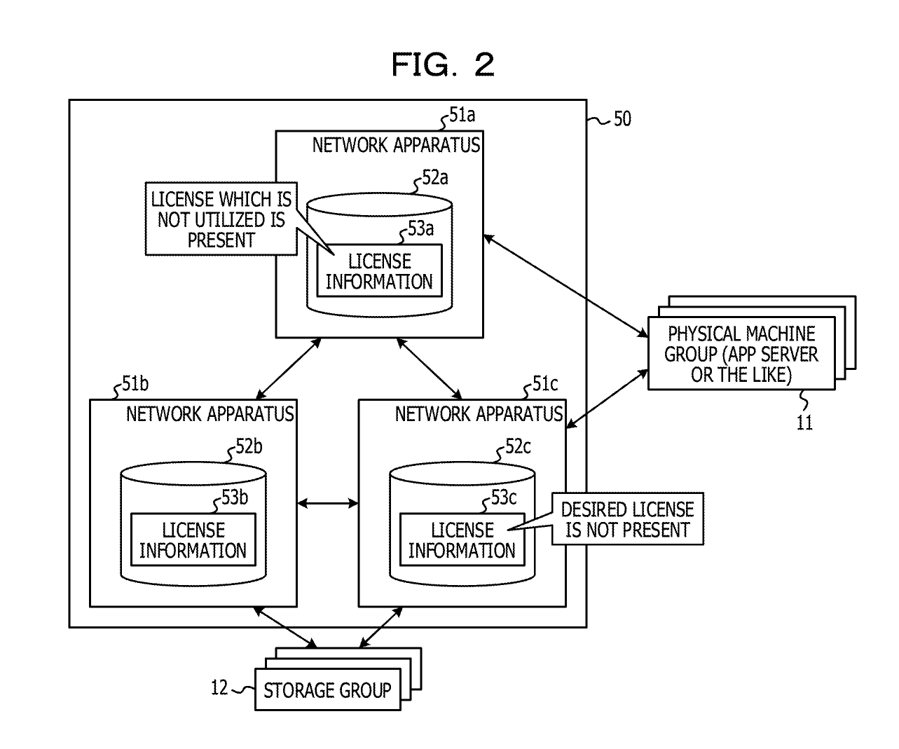

Next, description is made on a comparative example of the network apparatus group 10 described in FIG. 1. FIG. 2 is a diagram illustrating the comparative example of the network apparatus group 10 of FIG. 1.

A network apparatus group 50 illustrated in FIG. 2 includes a network apparatus 51a, a network apparatus 51b, and a network apparatus 51c. The network apparatus 51a includes a storing unit 52a, the network apparatus 51b includes a storing unit 52b, and the network apparatus 51c includes a storing unit 52c. The storing units 52a, 52b, and 52c each store license information 53a, 53b, or 53c that is information regarding a license for the function of which use is permitted to the corresponding network apparatus.

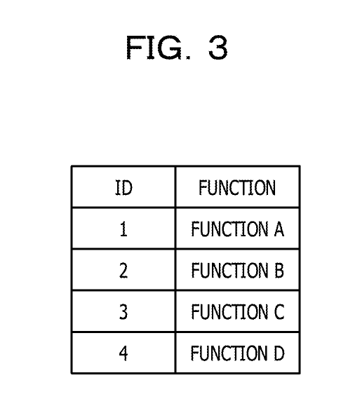

Next, description is made on an example of the license information 53a. FIG. 3 is a diagram illustrating an example of the license information 53a. The license information 53a illustrated in FIG. 3 includes an “ID” identifying respective pieces of information included in the license information 53a and a “function” identifying the function, of which use is permitted to the network apparatus 51a, as items. For example, the license information 53a illustrated in FIG. 3 indicates that functions, of which use are permitted to the network apparatus 51a, are a “function A”, a “function B”, a “function C”, and a “function D”. Contents of the license information 53b and 53c illustrated in FIG. 2 are similar to those of the license information 3a and thus, description thereof is not repeated.

The license for each function described in FIG. 3 is generally applied to the corresponding network apparatus. Thus, a manager of the network apparatus group 50 is not able to use the function, of which use is permitted to a certain network apparatus, to be utilized for other network apparatuses.

For example, as illustrated in FIG. 2, the network apparatus 51a may not use all the licenses of which use is permitted. Then, a situation in which a shortage of a license, which is not being used by the network apparatus 51a, may occur in the network apparatus 51c. However, even in such a case, the network apparatus 51a is not able to rent out the license, which is not being used, to the network apparatus 51c.

Accordingly, for example, in a case where the number of licenses which are desired to be used by respective network apparatuses that are included in the network apparatus group 50 is changed due to a configuration change of the business system, the provider may not be able to efficiently utilize the licenses of which use is permitted to respective network apparatuses.

In the present embodiment, the network apparatus 1a detects a change in the state of a connection between respective network apparatuses included in the network apparatus group 10. In a case where the change in the connection state is detected, the network apparatus 1a updates information of the license (including a license borrowed from other network apparatuses) capable of being used by the network apparatus 1a, based on information of the network apparatus of which the connection state is changed.

That is, in a case where respective network apparatuses included in the network apparatus group 10 perform license renting out or borrowing, respective network apparatuses included in the network apparatus group 10 are desired to manage information of the license capable of being rented out or borrowed at present by respective network apparatuses. The license capable of being rented out or borrowed by respective network apparatuses changes according to the change in the connection state of respective network apparatuses included in the network apparatus group 10. Accordingly, the network apparatus 1a updates information (hereinafter, also referred to as management information) of the license capable of being used by the network apparatus 1a according to the change in the connection state of respective network apparatuses included in the network apparatus group 10.

With this, the network apparatus 1a is able to maintain the contents of the management information up to date. Thus, respective network apparatuses included in the network apparatus group 10 are able to perform renting out and borrowing a license, of which use is permitted to the corresponding network apparatus, in accordance with information included in the management information.

Hardware Configuration of Network Apparatus

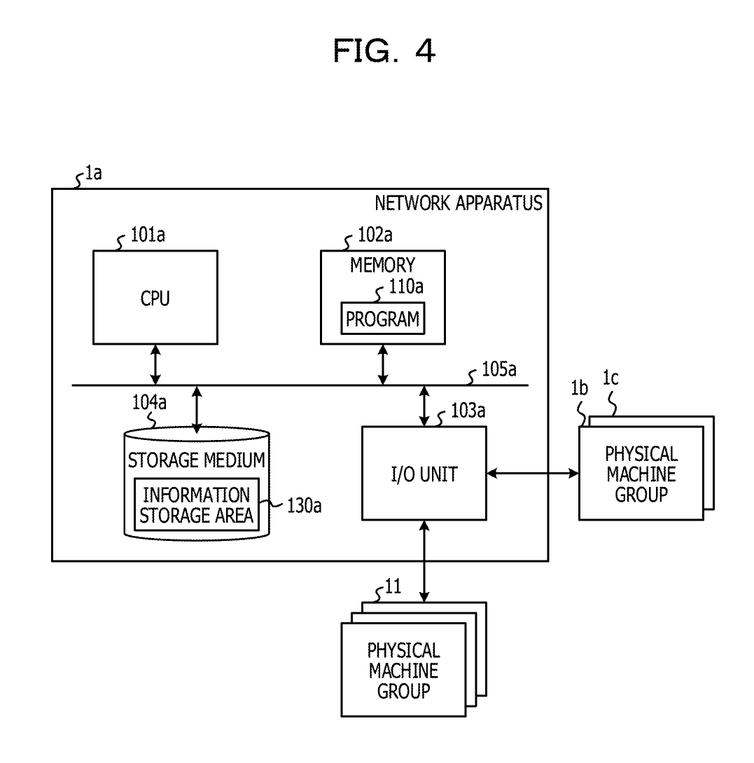

Next, description is made on a hardware configuration of the network apparatus 1a. FIG. 4 is a diagram illustrating a hardware configuration of the network apparatus 1a.

The network apparatus 1a includes a CPU 101a which is a processor, a memory 102a, an external interface (I/O unit) 103a, and a storage medium (storage) 104a. Respective units are connected with each other through a bus 105a.

The storage medium 104a stores a program 110a (hereinafter, also referred to as a license management program 110a) for performing a process (hereinafter, also referred to as a license management process) for managing the license of which use is permitted to the network apparatus 1a in a program storage area (not illustrated) within the storage medium 104a.

The CPU 101a, as illustrated in FIG. 4, loads the program 110a onto the memory 102a from the storage medium 104a when the program 110a is executed and cooperates with the program 110a to perform the license management process.

The storage medium 104a includes, for example, an information storage area 130a (hereinafter, also referred to as a storing unit 130a) which stores information used when the license management process is performed. The external interface 103a communicates with, for example, the physical machine group 11, the network apparatus 1b, and the network apparatus 1c.

The hardware configuration of the network apparatus 1b and the network apparatus 1c illustrated in FIG. 1 is the same as that of the network apparatus 1a and thus, description thereof is not repeated.

Software Configuration of Information Processing Device

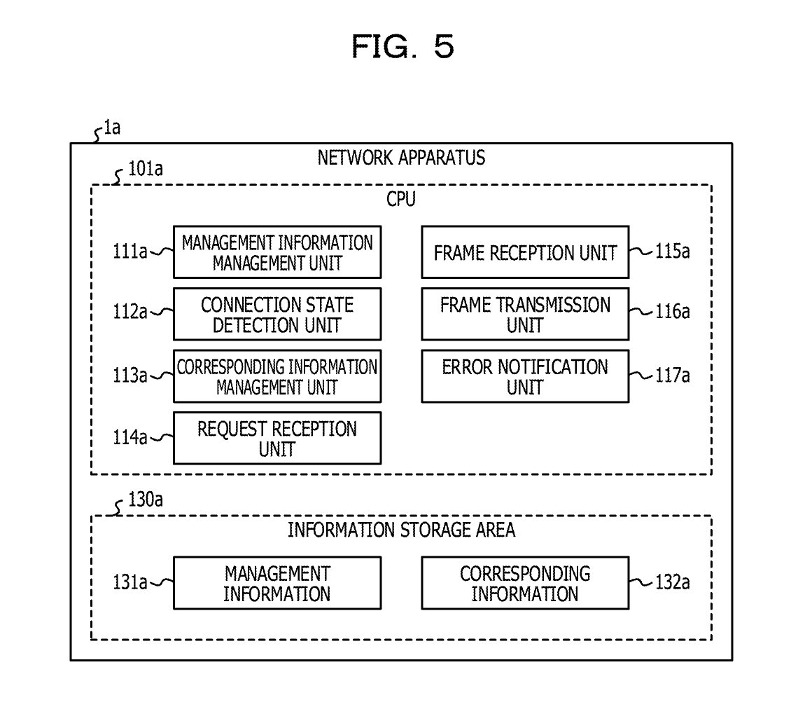

Next, description is made on a software configuration of the network apparatus 1a. FIG. 5 is a functional block diagram of the network apparatus 1a of FIG. 4. The CPU 101a cooperates with the program 110a and thus, operates as a management information management unit 111a (hereinafter, also simply referred to as a management unit 111a) and a connection state detection unit 112a (hereinafter, also simply referred to as a detection unit 112a). The CPU 101a cooperates with the program 110a and thus, operates as a corresponding information management unit 113a, a request reception unit 114a, a frame reception unit 115a, a frame transmission unit 116a, and an error notification unit 117a. Furthermore, management information 131a and corresponding information 132a are stored in the information storage area 130a.

The management information management unit 111a stores the management information 131a which is information regarding a license (hereinafter, also referred to as a second license), of which use is permitted to the network apparatus 1a, in the information storage area 130a. The management information 131a is information which indicates a license of which use is permitted to the network apparatus 1a. For example, the network apparatus 1a acquires information to use the license, of which use is permitted to the network apparatus 1a, by referring to the management information 131a and uses the license of which use is permitted. That is, the network apparatus 1a including the management information management unit 111a also functions as a license management device is which manages the license of which use is permitted to the network apparatus 1a.

Hereinafter, although description is made on a case where the network apparatus 1a also functions as the license management device 1a, for example, a device other than the network apparatuses 1a, 1b, and is may also be caused to function as the license management device.

The management information 131a includes information about the license (hereinafter, also referred to as a first license) borrowed by the network apparatus 1a in licenses of which use is permitted to other network apparatuses included in the network apparatus group 10. An example of the management information 131a is described later.

The connection state detection unit 112a detects a change in a connection state in the network of the network apparatus 1a. For example, in a case where connection of the network apparatus 1a and other network apparatuses included in the network apparatus group 10 is disconnected, the connection state detection unit 112a detects the disconnection. For example, in a case where a new network apparatus (including a network apparatus which was connected to the network apparatus group 10 in the past) is connected to the network apparatus group 10, the connection state detection unit 112a detects the connection.

The corresponding information management unit 113a stores corresponding information 132a, which is information for specifying each network apparatus included in the network apparatus group 10, in the information storage area 130a. The corresponding information 132a may be information which includes, for example, a domain ID (hereinafter, also referred to as first identifying information) and a serial number (hereinafter, also referred to as second identifying information) to which a network apparatus included in the network apparatus group 10 is allocated. An example of the corresponding information 132a is described later.

The request reception unit 114a receives information transmitted to the network apparatus 1a by the manager of the network apparatus group 10 (hereinafter, also simply referred to as a manager) in order to perform the license renting out and borrowing between the network apparatuses included in the network apparatus group 10. The request reception unit 114a receives information transmitted to the network apparatus 1a through a manager terminal (not illustrated) by the manager.

The frame reception unit 115a receives a frame transmitted from other network apparatuses included in the network apparatus group 10. The frame transmission unit 116a transmits a frame to other network apparatuses included in the network apparatus group 10. A frame is the smallest unit of a data received and transmitted between a plurality of fiber channel switches. An example of the frame received and transmitted by the network apparatus 1a is described later.

In a case where a result of processing executed based on the frame received by the frame reception unit 115a is abnormal, the error notification unit 117a notifies contents of the abnormality or the like to the manager.

The software configuration of the network apparatus 1b and the network apparatus 1c described in FIG. 1 is the same as that of the network apparatus 1a and thus, description thereof is not repeated. Hereinafter, it is assumed that a management information management unit 111c, a connection state detection unit 112c, and a corresponding information management unit 113c of the network apparatus 1c perform the same processing performed by the management information management unit 111a, the connection state detection unit 112a, and the corresponding information management unit 113a, respectively. Hereinafter, it is assumed that a request reception unit 114c, a frame reception unit 115c, a frame transmission unit 116c, and an error notification unit 117c of the network apparatus 1c perform the same processing performed by the request reception unit 114a, the frame reception unit 115a, the frame transmission unit 116a, and the error notification unit 117a, respectively.

Outline of First Embodiment

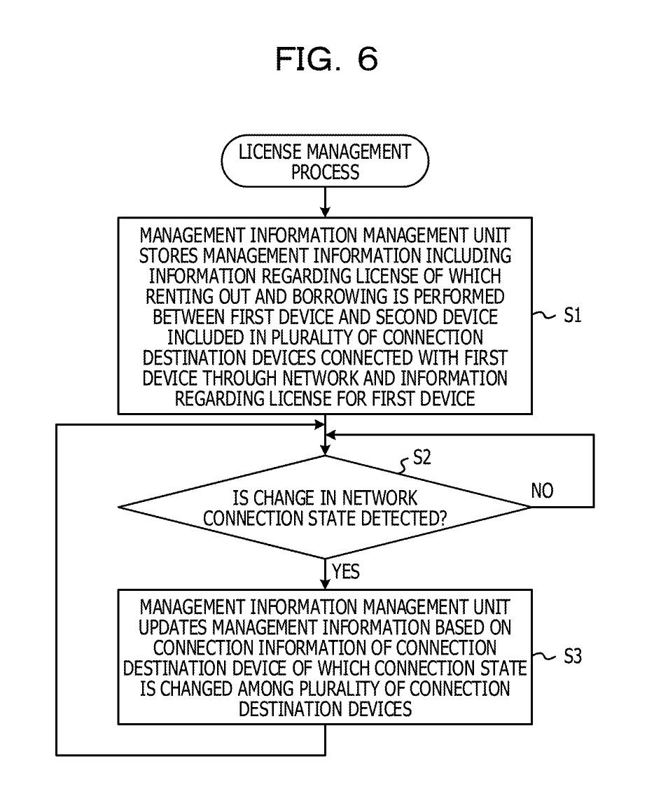

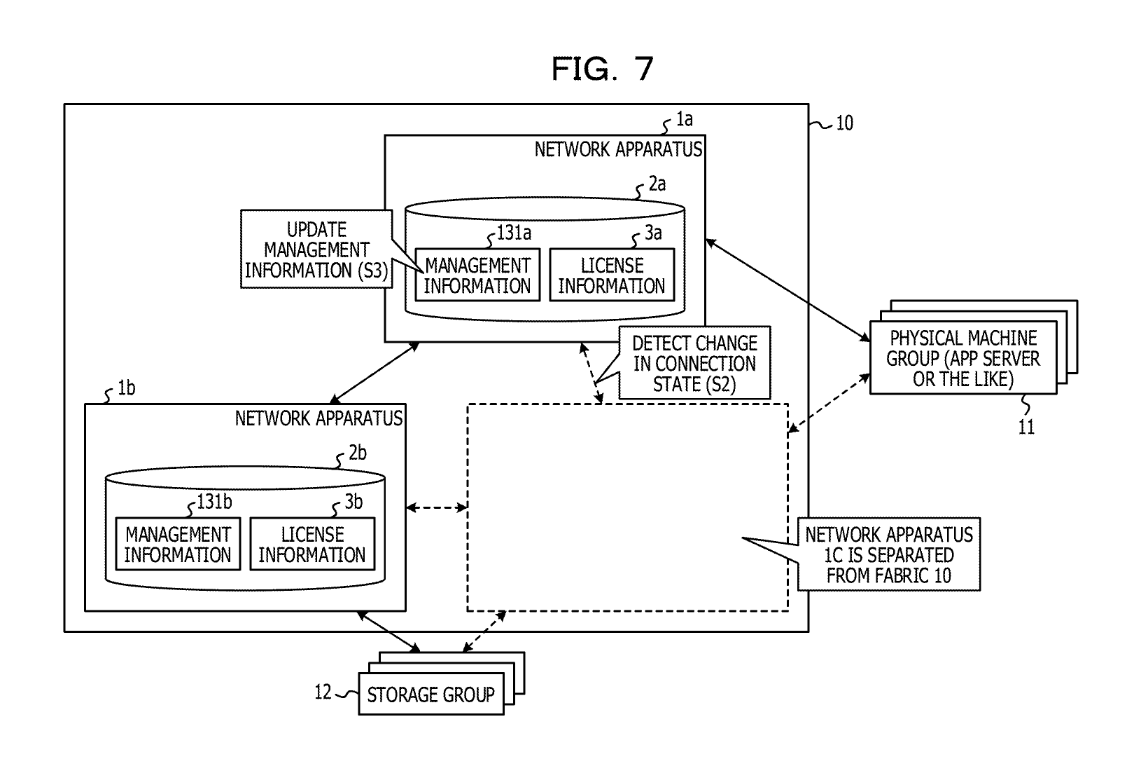

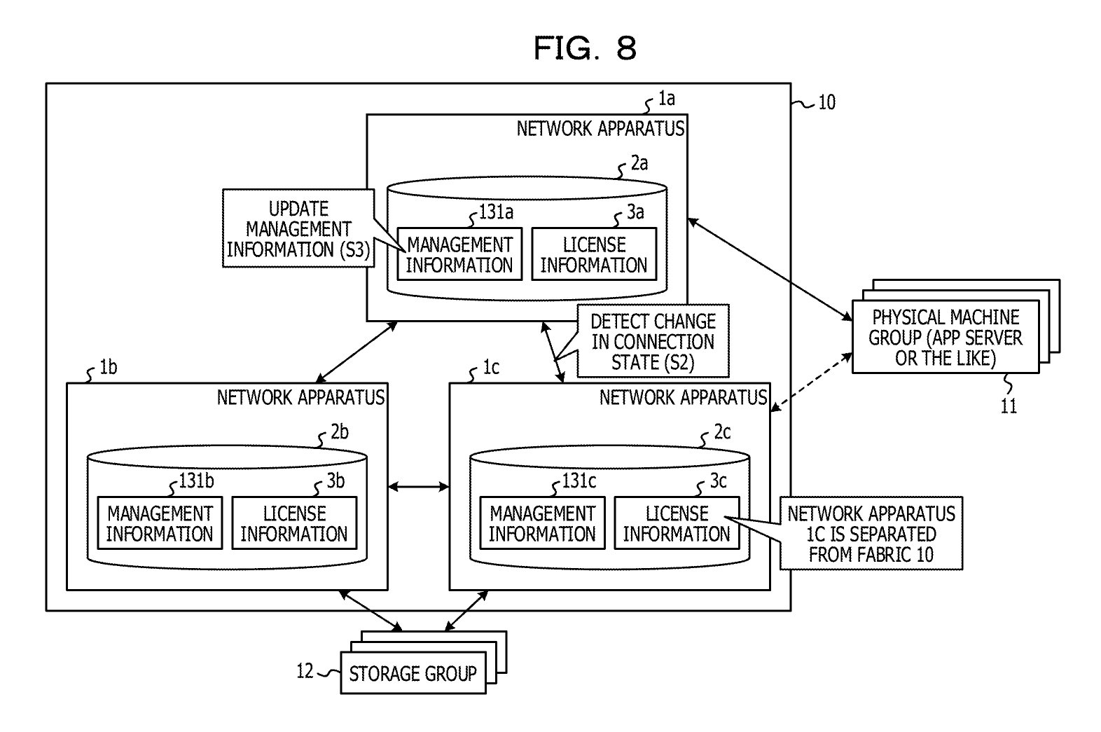

Next, description is made on an outline of the first embodiment. FIG. 6 is a flowchart illustrating an outline of a license management process in a first embodiment. FIG. 7 and FIG. 8 are diagrams illustrating the outline of the license management process in the first embodiment. Description is made on the license management process of FIG. 6 while referring to FIG. 7 and FIG. 8.

Outline of License Management Process

The management information management unit 111a of the network apparatus 1a, as illustrated in FIG. 6, stores the management information 131a which includes information about the license, which is rented out and borrowed between the second devices 1b and 1c included in a plurality of connection destination devices connected to the first device 1a through the network, and information about the license of the first device 1a (S1). The management information management unit 111a waits until a change in the network connection state is detected (NO in S2).

Thereafter, in a case where the change in the network connection state is detected (YES in S2), the management information management unit 111a updates the management information 131a based on connection information of a connection destination device, of which a connection state is changed, among the plurality of connection destination devices (S3).

That is, the license capable of being rented out and borrowed in the network apparatus group 10 is changed according to the connection state of the network in the network apparatus group 10. Thus, in a case where there is a change in the connection state of respective network apparatuses included in the network apparatus group 10, respective network apparatuses included in the network apparatus group 10 update the management information 131a. Accordingly, the respective network apparatuses included in the network apparatus group 10 are able to perform the license renting out and borrowing, based on the management information 131a which is in a state of being reflected with the latest connection state.

As illustrated in FIG. 7, in a case where the network apparatus 1c included in the network apparatus group 10 is separated from the network apparatus group 10, the network apparatus 1c may start to use, for example, the license which is rented out to another network apparatus (network apparatus 1a or network apparatus 1b). Thus, in a case where the network apparatus 1c is separated from the network apparatus group 10, the network apparatus which has borrowed the license from the network apparatus 1c is desired to stop the use of the license borrowed from the network apparatus 1c. Therefore, in the example illustrated in FIG. 7, the network apparatus 1a and the network apparatus 1b respectively update the management information 131a and the management information 131b to include information that the network apparatus 1c is separated from the network apparatus group 10.

On the other hand, as illustrated in FIG. 8, in a case where connection of the network apparatus 1c separated from the network apparatus group 10 with the network apparatus included in the network apparatus group 10 is resumed, the network apparatus 1a and the network apparatus 1b may borrow the license of the network apparatus 1c again. Thus, in this case, the network apparatus 1a and the network apparatus 1b respectively update the management information 131a and the management information 131b to include information that the network apparatus 1c is returned to the network apparatus group 10.

As such, the network apparatus 1a includes the management information management unit 111a storing the management information 131a which includes information about the license which is rented out and borrowed between the network apparatus 1a and a plurality of connection destination devices connected with each other through a network and storing information about the license of the network apparatus 1a. The network apparatus 1a includes the connection state detection unit 112a to detect the change in the connection state in the network. Furthermore, the network apparatus 1a includes the management information management unit 111a to update, in a case where the connection state detection unit 112a detects the change in the connection state, the management information 131a based on connection information of the connection destination device, of which the connection state is changed, among the plurality of connection destination devices.

With this, the network apparatus 1a is able to manage the latest information about the license capable of being rented out and borrowed by respective network apparatuses included in the network apparatus group 10 as the management information 131a. The network apparatus 1a is able to perform the license renting out and borrowing based on the management information 131a.

Details of First Embodiment

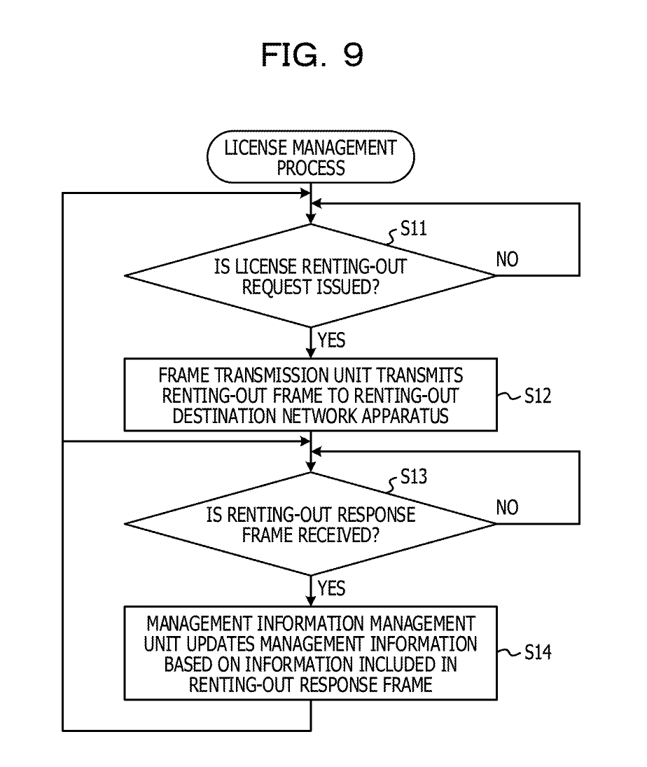

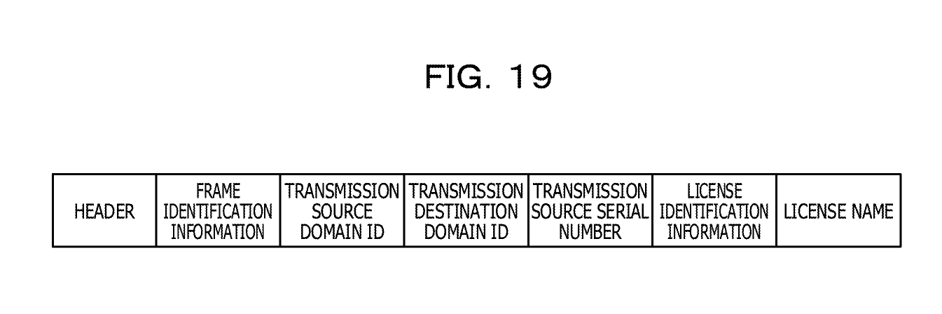

Next, description is made on details of the first embodiment. FIG. 9 to FIG. 18 are flowcharts illustrating details of the license management process in the first embodiment. FIG. 19 to FIG. 33B are diagrams illustrating details of the license management process in the first embodiment. Description is made on the license management process of FIG. 9 to FIG. 18 while referring to FIG. 19 to FIG. 33B.

License Renting-Out Process

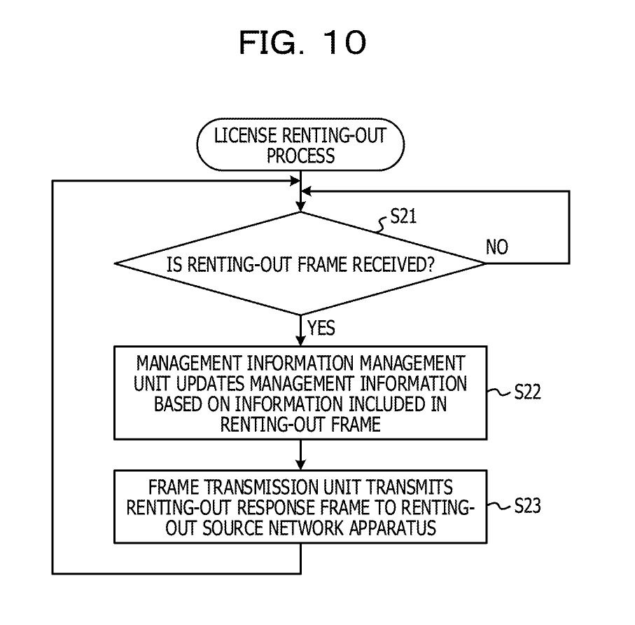

Description is made on a process (hereinafter, also simply referred to as a license renting-out process), which is performed when the license renting out is performed, of the license management process. FIG. 9 and FIG. 10 are flowcharts illustrating the license renting-out process in the first embodiment. Hereinafter, description is made on a case where the network apparatus 1a rents out the license to the network apparatus 1c.

License Renting-Out Process In Renting-Out Source Network Apparatus

Description is made on the license renting-out process in the license renting-out source network apparatus (network apparatus 1a).

As illustrated in FIG. 9, the request reception unit 114a of the network apparatus 1a, for example, waits until a license renting-out request is issued from the manager (NO in S11). The request reception unit 114a, for example, waits until the manager transmits the license renting-out request through the manager terminal.

That is, for example, in a case where the manager determines to perform the license renting out and borrowing between the network apparatuses included in the network apparatus group 10, the manager transmits a license renting-out request for requesting renting out of a license to the network apparatus 1a which becomes the license renting-out source. With this, the network apparatus 1a is able to start the license renting-out process.

In a case where the license renting-out request is received (YES in S11), the frame transmission unit 116a of the network apparatus 1a transmits a renting-out frame for performing the license renting out to a license renting-out destination network apparatus (network apparatus 1c) (S12). Hereinafter, description is made on an example of the renting-out frame.

FIG. 19 is a diagram illustrating an example of a renting-out frame. In the example illustrated in FIG. 19, the renting-out frame includes, as information, a header of a frame, identification information identifying a type of a renting-out frame, and a domain ID of the network apparatus (network apparatus 1a) of the frame transmission source. In the example illustrated in FIG. 19, the renting-out frame includes, as information, a domain ID of a frame transmission destination network apparatus (network apparatus 1c) and a serial number allocated to a frame transmission source network apparatus (network apparatus 1a). In the example illustrated in FIG. 19, the renting-out frame includes, as information, license identification information which identifies a renting-out target license and a license name of the renting-out target license as information.

With this, the renting-out destination network apparatus (network apparatus 1c) which has received the renting-out frame, as is described later, is able to update the management information 131c based on information included in the renting-out frame. The network apparatus 1c is able to use the license (license of which use is permitted to the network apparatus 1a) specified in the license identification information included in the renting-out frame.

Referring back to FIG. 9, the frame reception unit 115a of the network apparatus 1a waits until the renting-out response frame is received from the license renting-out destination network apparatus (network apparatus 1c) (NO in S13). The renting-out response frame is a frame which includes information indicating an execution state (execution result) of a process executed in the license renting-out destination network apparatus (network apparatus 1c) based on the renting-out frame transmitted by the license renting-out source network apparatus (network apparatus 1a). Hereinafter, description is made on an example of the renting-out response frame.

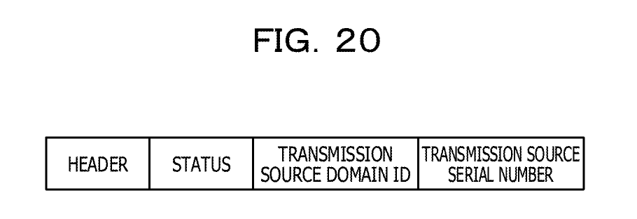

FIG. 20 is a diagram illustrating an example of a renting-out response frame. In the example illustrated in FIG. 20, the renting-out response frame includes, as information, a header of a frame, and a status indicating the execution state of the process in the frame transmission source network apparatus (network apparatus 1c). Information indicating “Normal”, which indicates that an execution of the process based on the renting-out frame is normally completed, is set in the status within the renting-out response frame, for example, in the frame transmission source network apparatus (network apparatus 1c). Information indicating “Abnormal”, which indicates that an execution of the process based on the renting-out frame is not normally completed, is set in the status within the renting-out response frame, for example, in the frame transmission source network apparatus (network apparatus 1c). In the example illustrated in FIG. 20, the renting-out response frame includes, as information, a domain ID of the frame transmission source network apparatus (network apparatus 1c) and a serial number allocated to the frame transmission source network apparatus (network apparatus 1c).

With this, the network apparatus 1a which has received the renting-out response frame is able to acquire information about the execution state of the process executed in the network apparatus 1c. The network apparatus 1a, as is described later, is able to update the management information 131a, based on information included in the renting-out response frame.

Referring back to FIG. 9, in a case where the renting-out response frame is received (YES in S13), the management information management unit 111a updates the management information 131a based on information included in the renting-out response frame (S14). An example of the processing of S14 is described later.

License Renting-Out Process In Renting-Out Destination Network Apparatus

Next, description is made on the license renting-out process in the renting-out destination network apparatus (network apparatus 1c).

The frame reception unit 115c of the network apparatus 1c, as illustrated in FIG. 10, waits until the renting-out frame is received from the license renting-out source network apparatus (network apparatus 1a) (NO in S21). In a case where the renting-out frame is received (YES in S21), the management information management unit 111c of the network apparatus 1c updates the management information 131c based om information included in the renting-out response frame (S22). An example of the processing of S22 is described later.

Thereafter, the frame transmission unit 116c of the network apparatus 1c transmits the renting-out response frame, which corresponds to the renting-out frame received by the frame reception unit 115c in S21, to the license renting-out source network apparatus (network apparatus 1a) (S23). Hereinafter, description is made on an example of the processing of S14 and S22.

Example of Processing of S14 and S22

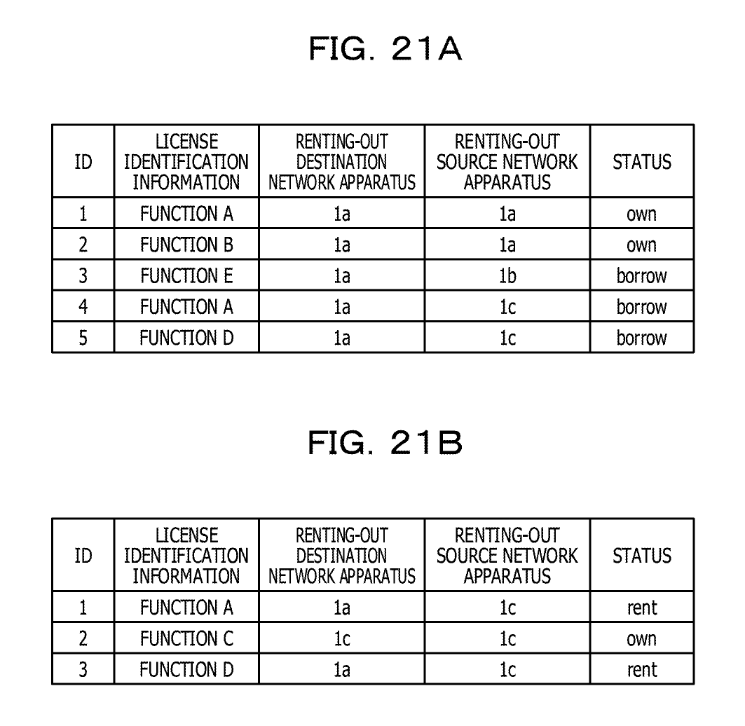

FIG. 21A and FIG. 21B are diagrams illustrating an example of management information 131a and management information 131c before processing of S14 and S22 is executed. FIG. 21A is an example of the management information 131a before the processing of S14 is executed and FIG. 21B is an example of the management information 131c before the processing of S22 is executed. Hereinafter, the network apparatus 1a, the network apparatus 1b, and the network apparatus 1c are also simply denoted by 1a, 1b and 1c, respectively.

The management information 131a illustrated in FIG. 21A includes, as items, an “ID” identifying respective pieces of information included in the management information 131a, “license identification information” identifying respective licenses, and the “renting-out destination network apparatus” identifying respective license renting-out destination network apparatuses. The management information 131a illustrated in FIG. 21A includes the “renting-out source network apparatus” identifying respective license renting-out source network apparatuses, and a “status” indicating renting-out states of the respective licenses.

The term of “own” indicating that the license, which is not rented out to other devices, in the licenses of which use is permitted to the device, is set in the “status”. The term of “rent” (hereinafter, also referred to as first renting-out information) indicating that the license is rented out to other devices and the term of “borrow” (hereinafter, also referred to as first borrowing information) indicating that the license is borrowed from other devices are set in the “status”. The term of “rent-disconnect” (hereinafter, also referred to as second renting-out information), which indicates that the license is rented out to another device but connection with the other device of the renting-out destination is disconnected, is set in the “status”. Furthermore, the term of “borrow-disconnect” (hereinafter, also referred to as second borrowing information), which indicates that the license is borrowed from another device but connection with the other device of the renting-out destination is disconnected, is set in the “status”. That is, the license capable of being used by the device itself corresponds to a license for which the term of “own” or “borrow” is set in the “status”.

For example, the “function A” is set in information having the “ID” of “1” as the “license identification information”, and the term of “1a” is set in the “renting-out destination network apparatus”, and the term of “1a” is set in the “renting-out source network apparatus” in the management information 131a illustrated in FIG. 21A. Also, the “own” is set as the “status” in the information having the “ID” of “1” in the management information 131a illustrated in FIG. 21A. That is, since the license having the “ID” of “1” is a license which is in a state capable of being used by the device itself (a state of not being rented out to another device), the “1a”, which indicates the device itself, is set in both of the “renting-out destination network apparatus” and the “renting-out source network apparatus”.

The “function D” is set in information having the “ID” of “5” as the “license identification information”, and the“1a” is set in the “renting-out destination network apparatus” and the term of “1c” is set in the “renting-out source network apparatus” in the management information 131a illustrated in FIG. 21A. Also, the term of “borrow” is set as the “status” in the information having the “ID” of “5” in the management information 131a illustrated in FIG. 21A. That is, the license having the “ID” of “5” is a license which is in a state capable of being used by the device itself by borrowing the license from another device (network apparatus 1c). Therefore, the “1c” is set in the “renting-out source network apparatus” corresponding to information having the “ID” of “5”. Description on other pieces of information included in FIG. 21A is not repeated again.

Next, description is made on the management information 131c illustrated in FIG. 21B. The management information 131c illustrated in FIG. 21B has the same items as those of the management information 131a illustrated in FIG. 21A.

For example, the “function D” is set in information having the “ID” of “3” as the “license identification information” and the “1a” is set in the “renting-out destination network apparatus” and the “1c” is set in the “renting-out source network apparatus” in the management information 131c illustrated in FIG. 21B. Also, the “rent” is set as the “status” in the information having the “ID” of “3” in the management information 131c illustrated in FIG. 21B. That is, the license having the “ID” of “3” is a license which is rented out to the network apparatus 1a. The information having the “ID” of “3” is information including the same contents as those of the information having the “ID” of “5” and included in the management information 131a as illustrated in FIG. 21A. Description on other pieces of information included in FIG. 21B is not repeated again. Hereinafter, description is made on an example of the management information 131a and the management information 131c after the processing of S14 and S22 is executed.

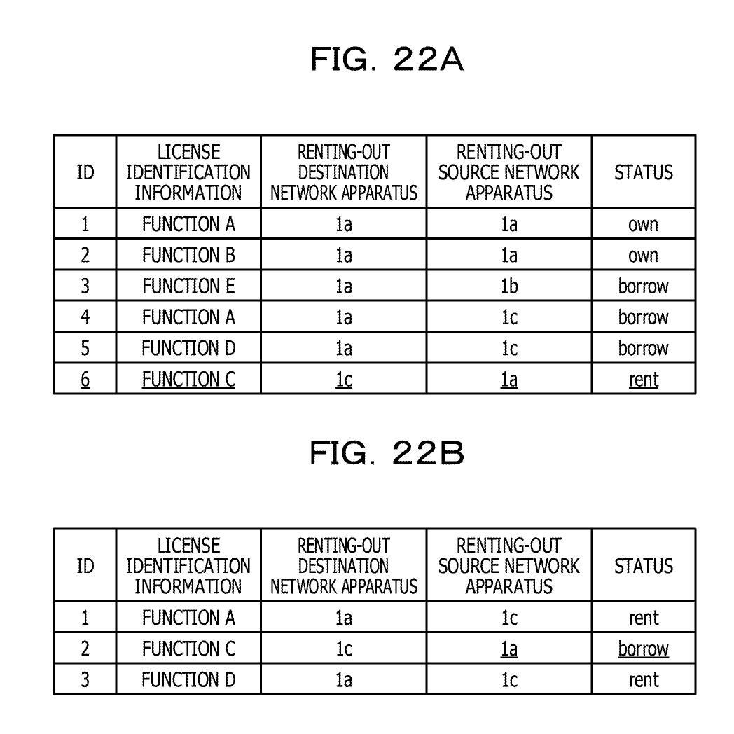

FIG. 22A and FIG. 22B are diagrams illustrating an example of the management information 131a and the management information 131c after the processing of S14 and S22 is executed. FIG. 22A is a diagram illustrating an example of the management information 131a after the processing of S14 is executed and FIG. 22B is a diagram illustrating an example of the management information 131c after the processing of S22 is executed. Hereinafter, description is made on a case where the license having the “ID” of “2” and included in the management information 131c of FIG. 22B is rented out from the network apparatus 1c to the network apparatus 1a.

In the management information 131a illustrated in FIG. 22A, information having the “ID” of “6” (underlined portion of FIG. 22A) is added, compared with the management information 131a illustrated in FIG. 21A. For example, the “function C” is set in information having the “ID” of “6”, as the “license identification information”, and the term of “1c” is set in the item of the “renting-out destination network apparatus” in the management information 131a illustrated in FIG. 22A. Also, the “1a” is set in information having the “ID” of “6” as the “renting-out destination network apparatus” and the “rent” is set as the “status” in the management information 131a illustrated in FIG. 22A. That is, information including the same contents as those of the information having the “ID” of “2” included in the management information of FIG. 21B is set in the information having the “ID” of “6 of the management information 131a illustrated in FIG. 22A.

On the other hand, in the management information 131b illustrated in FIG. 22B, the “status” of the information having the “ID” of “2” is updated with the “borrow” (underlined portion of FIG. 22B), compared with the management information 131a illustrated in FIG. 22A.

That is, in a case where the license renting out and borrowing occurs between the network apparatuses included in the network apparatus group 10, the management information management unit 111a and the management information management unit 111c update the management information 131a and the management information 131c, respectively, based on the contents of the renting out and borrowing that has occurred.

Respective network apparatuses included in the network apparatus group 10 may also be able to use, for example, the license of which “status” is updated during a predetermined period of time even after the “status” of information corresponding to the license being used is updated with a status other than the “own” and “borrow”. With this, the manager is able to operate the business system incorporating the network apparatus group 10 more stably.

License Renting-Out End Process

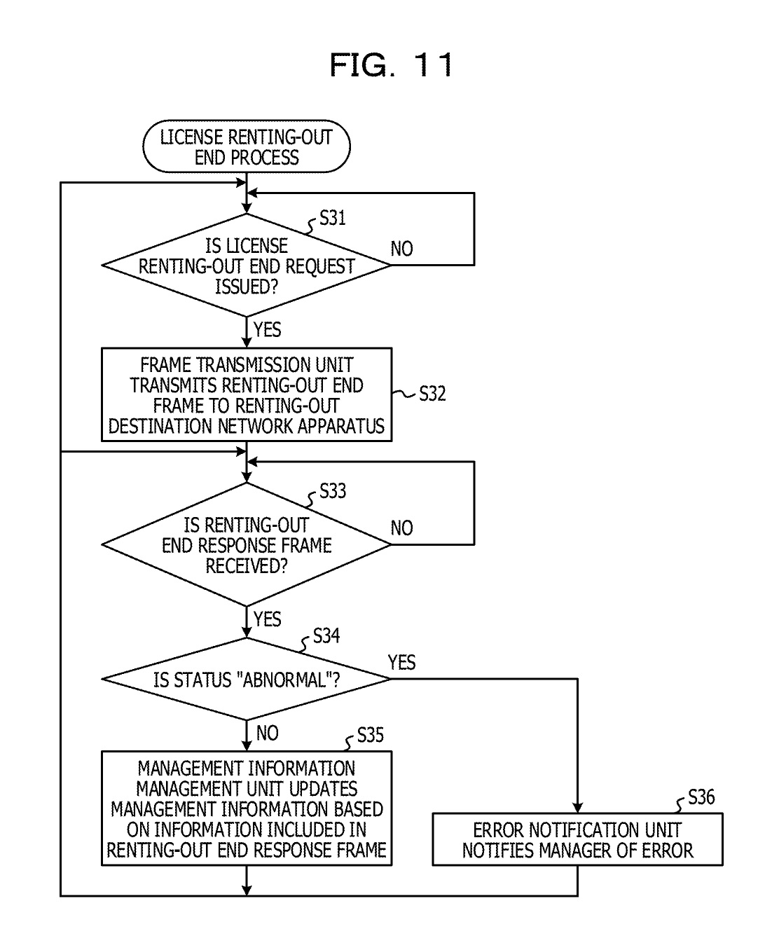

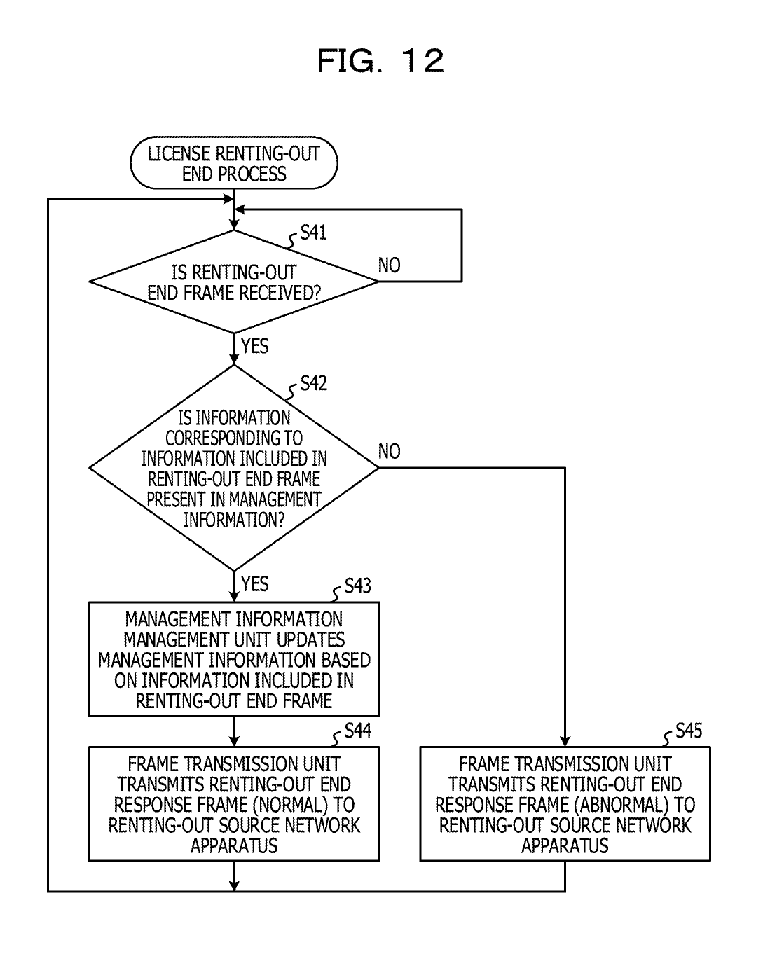

Next, description is made on a process (hereinafter, simply referred to as a license renting-out end process) performed when the license renting out is ended (license is returned) of the license management process. FIG. 11 and FIG. 12 are flowcharts illustrating a license renting-out end process in the first embodiment. Hereinafter, description is made on a case where the license, which is rented out to the network apparatus 1c by the network apparatus 1a, is returned.

License Renting-Out End Process In Renting-Out Source Network Apparatus

Description is made on the license renting-out end process in the renting-out source network apparatus (network apparatus 1a).

As illustrated in FIG. 11, for example, the request reception unit 114a waits until the license renting-out end request is issued from the manager (NO in S31). The request reception unit 114a, for example, waits until the manager transmits the renting-out end request through the manager terminal.

That is, for example, in a case where the manager determines to end the license renting out and borrowing between the network apparatuses included in the network apparatus group 10, the manager transmits the license renting-out end request for requesting to end the license renting out to the network apparatus which becomes the license renting-out source. With this, the renting-out source network apparatus (network apparatus 1a) which has received the license renting-out end request is able to start the license renting-out end process.

In a case where the license renting-out end request is received (YES in S31), the frame transmission unit 116a transmits the renting-out end frame for ending the license renting out to the license renting-out destination network apparatus (network apparatus 1c) (S32). Hereinafter, description is made on an example of the renting-out end frame.

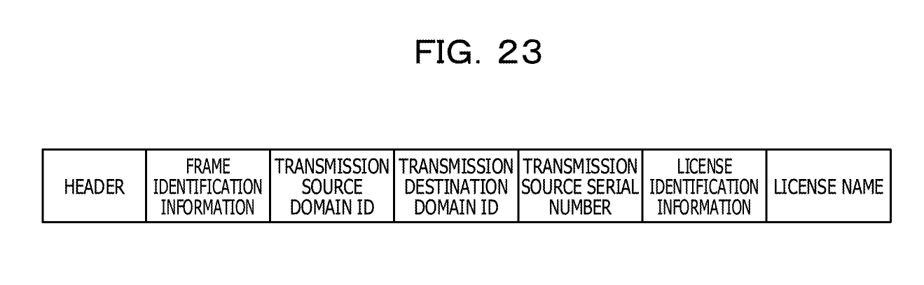

FIG. 23 is a diagram illustrating an example of a renting-out end frame. In the example illustrated in FIG. 23, the renting-out end frame includes, as information, a header of a frame, identification information identifying a type of the renting-out frame, and a domain ID of the network apparatus (network apparatus 1a) of the frame transmission source. In the example illustrated in FIG. 23, the renting-out end frame includes, as information, a domain ID of frame transmission destination network apparatus (network apparatus 1c) and a serial number allocated to the frame transmission source network apparatus (network apparatus 1a). In the example illustrated in FIG. 23, the renting-out end frame includes, as information, license identification information identifying a license of which renting out is to be ended and a license name of the license of which renting out is to be ended.

With this, the network apparatus 1c which has received the renting-out frame, as is described later, is able to update the management information 131c based on information included in the renting-out end frame.

Referring back to FIG. 11, the frame reception unit 115a of the network apparatus 1a waits until the renting-out end response frame is received from the license renting-out destination network apparatus (network apparatus 1c) (NO in S33). The renting-out end response frame is a frame which includes information indicating an execution state (execution result) of a process executed by the license renting-out destination network apparatus (network apparatus 1c) based on the renting-out frame transmitted by the license renting-out source network apparatus (network apparatus 1a). Since information included in the renting-out end response frame is the same as that included in the renting-out response frame described in FIG. 20, descriptions thereof is not repeated.

In a case where the renting-out response frame is received (YES in S33), the frame reception unit 115a determines whether information which is set in the “status” included in the received renting-out response frame is “abnormal” or not (S34). As a result, in a case where the “abnormal” is not set in the “status” included in the received renting-out response frame (NO in S34), the management information management unit 111a updates the management information 131a based on the information included in the renting-out end response frame (S35). An example of the processing of S35 is described later.

On the other hand, in a case where the “abnormal” is set in the “status” included in the received renting-out response frame (YES in S34), the error notification unit 117a of the network apparatus 1a notifies, for example, the manager that an error has occurred in the renting-out destination network apparatus (network apparatus 1a) (S36).

License Renting-Out End Process In Renting-Out Destination Network Apparatus

Next, description is made on the license renting-out end process in the renting-out destination network apparatus (network apparatus 1c).

The frame reception unit 115c, as illustrated in FIG. 12, waits until the renting-out end frame is received from the license renting-out source network apparatus (network apparatus 1a) (NO in S41). In a case where the renting-out end frame is received (YES in S41), the frame reception unit 115c determines whether information corresponding to the information included in the received renting-out end frame is present in the management information 131c or not (S42). As a result, in a case where the information corresponding to the information included in the received renting-out end frame is present in the management information 131c (YES in S42), the management information management unit 111c updates the management information 131c based on the information included in the received renting-out end frame (S43). An example of the processing of S43 is described later.

Thereafter, the frame transmission unit 116c transmits the renting-out end response frame for which the “normal” is set in the “status” to the license renting-out source network apparatus (network apparatus 1a) (S44).

On the other hand, in a case where the information corresponding to the information included in the received renting-out end frame is not present in the management information 131c (NO in S42), the frame transmission unit 116c transmits the renting-out end response frame for which the “abnormal” is set in the “status” to the license renting-out source network apparatus (network apparatus 1a) (S45). Hereinafter, description is made on an example of the processing of S35 and S43.

Example of Processing of S35 and S43

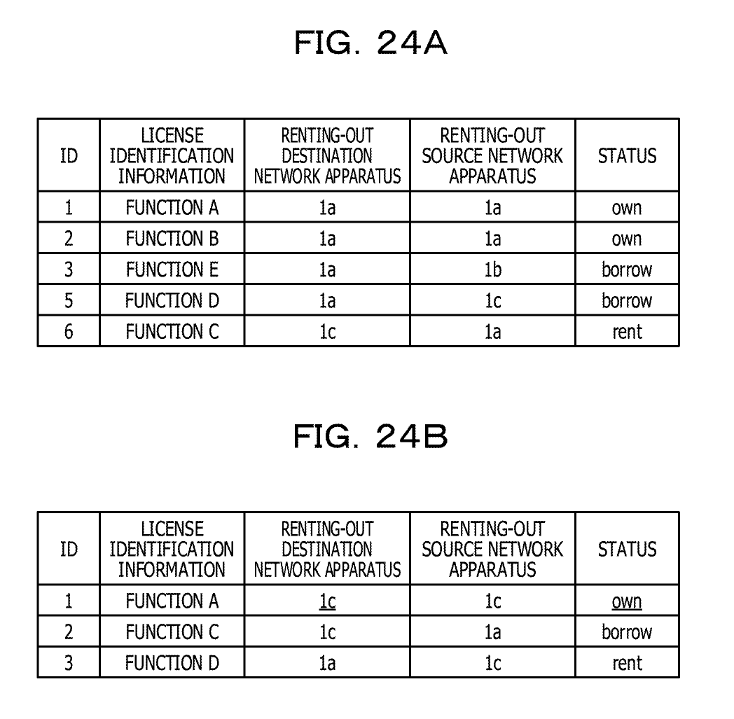

FIG. 24A and FIG. 24B are diagrams illustrating an example of the management information 131a and the management information 131c after processing of S35 and S43 is executed from a state of the management information 131a and the management information 131c illustrated in FIG. 21A and FIG. 21B. FIG. 24A is a diagram illustrating an example of the management information 131a after processing of S35 is executed and FIG. 24B is a diagram illustrating an example of the management information 131c after processing of S43 is executed. Hereinafter, description is made on a case where renting out of the license of which the “ID” included in the management information of FIG. 22B is “1” is ended (in a case where the license is returned from network apparatus 1a to network apparatus 1c).

The information of which the “ID” is “4” has been deleted in the management information 131a illustrated in FIG. 24A, compared with the management information 131a illustrated in FIG. 22A. On the other hand, information, which is set in the “renting-out destination network apparatus ” of the information of which the “ID” is “1”, is updated with “1c” (underlined portion of FIG. 24B) in the management information 131c illustrated in FIG. 24B, compared with the management information 131c illustrated in FIG. 22B. Information, which is set in the “status” of the information of which the “ID” is “1”, is updated with the “own” (underlined portion of FIG. 24B) in the management information 131b illustrated in FIG. 24B, compared with the management information 131c illustrated in FIG. 22B.

That is, in a case where the license renting out and borrowing between the network apparatuses included in the network apparatus group 10 is ended, the management information management unit 111a and the management information management unit 111c update the management information 131a and the management information 131c, respectively, based on contents of the license of which the renting out and borrowing is ended. For example, the management information management unit 111a and the management information management unit 111c update the management information 131a and the management information 131c, respectively, in order to indicate that the license returned from the network apparatus 1c is not rented out to other network apparatuses.

With this, the network apparatus 1a itself is able to use the license returned from the network apparatus 1c. The network apparatus 1a is also able to rent out the license returned from the network apparatus 1c to another network apparatus (for example, network apparatus 1b).

Disconnection Detection Process

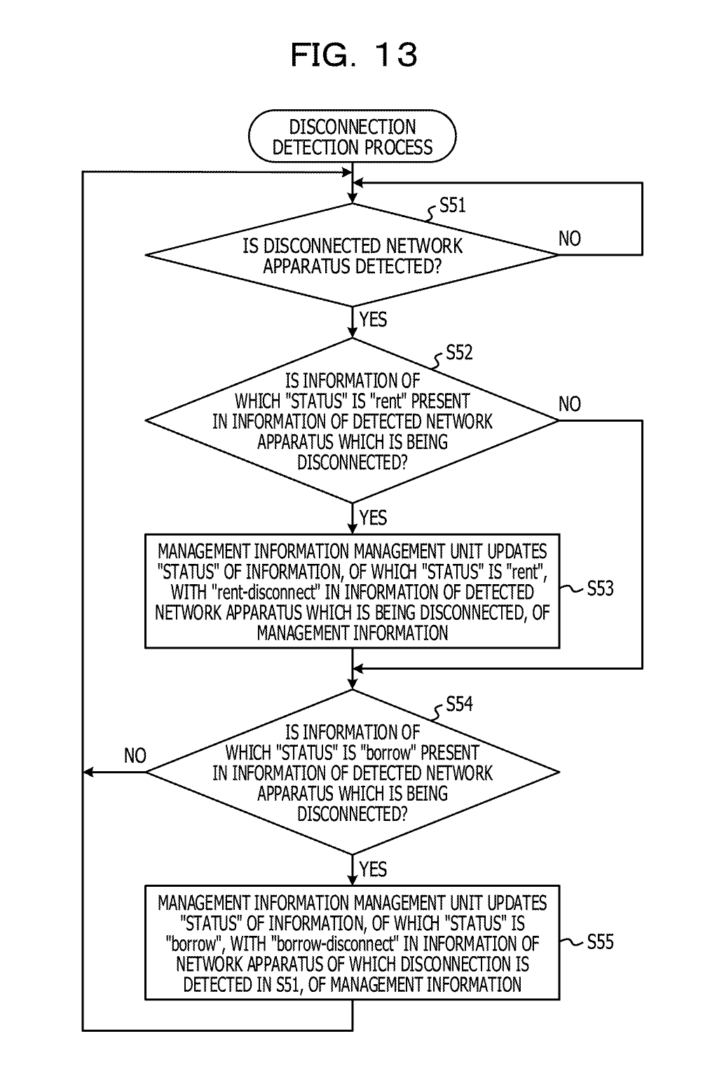

Next, description is made on a process, which is performed (hereinafter, also simply referred to as disconnection detection process) when disconnection from the network apparatus included in the network apparatus group 10 is detected, of the license management process. FIG. 13 is a flowchart illustrating a disconnection detection process in the first embodiment. The disconnection detection process is executed in all the network apparatuses included in the network apparatus group 10. Hereinafter, description is made on a case where the network apparatus 1a executes the disconnection detection process. Hereinafter, description is made on the assumption that connection of the network apparatus 1a and the network apparatus 1c is disconnected.

The connection state detection unit 112a of the network apparatus 1a, as illustrated in FIG. 13, waits until the network apparatus disconnected from another network apparatus included in the network apparatus group 10 is detected (NO in S51). In a case where the network apparatus disconnected from another network apparatus is detected (YES in S51), the management information management unit 111a determines whether information of which the “status” is “rent” in the information of the detected network apparatus (network apparatus 1c), which is being disconnected, is present in the management information 131a or not (S52). As the determination result, in a case where the information of which the “status” is the “rent” is present (YES in S52), the management information management unit 111a updates the “rent”, which is the “status” of the information which is present, of the management information 131a with “rent-disconnect” (S53). On the other hand, in a case where the information of which the “status” is the “rent” is not present (NO in S52), the management information management unit 111a does not update the management information 131a.

That is, in a case where connection with the license renting-out destination network apparatus is disconnected, the management information management unit 111a does not set the “own”, which is information indicating that a relationship between the renting out and the borrowing of the license is dissolved, in the management information 131a. The management information management unit 111a sets the “rent-disconnect”, which is information indicating that a relationship between the renting out and the borrowing of the license is maintained, in the management information 131a.

With this, the management information management unit 111a is able to avoid that the license, which is being rented out to the disconnected network apparatus, is being rented out to another network apparatus. Accordingly, for example, in a case where connection with the disconnected network apparatus is resumed, the management information management unit 111a is able to avoid a situation where the same license is rented out to a plurality of network apparatuses from occurring.

The management information management unit 111a determines whether information of which the “status” is “borrow” in the information, which corresponds to the detected network apparatus, which is being disconnected, is present in the management information 131a or not (S54). As the determination result, in a case where the information of which the “status” is the “borrow” is present (YES in S54), the management information management unit 111a updates the “borrow”, which is the “status” of the information which is present, of the management information 131a with “borrow-disconnect” (S55). On the other hand, in a case where the information of which the “status” is the “borrow” is not present (NO in S54), the management information management unit 111a does not update the management information 131a.

That is, in a case where connection with the license renting-out source network apparatus is disconnected, similar to the case described above, the management information management unit 111a sets “borrow-disconnect” in the “status” of information corresponding to the disconnected network apparatus and maintains the relationship between the renting out and the borrowing of the license. With this, for example, in a case where the connection with the disconnected network apparatus is resumed just after the disconnection, the network apparatus 1a is able to use the license that is borrowed without executing the processing for performing the license renting out and borrowing again. Hereinafter, description is made on an example of processing of S53 and S55.

Example of Processing of S53 and S55

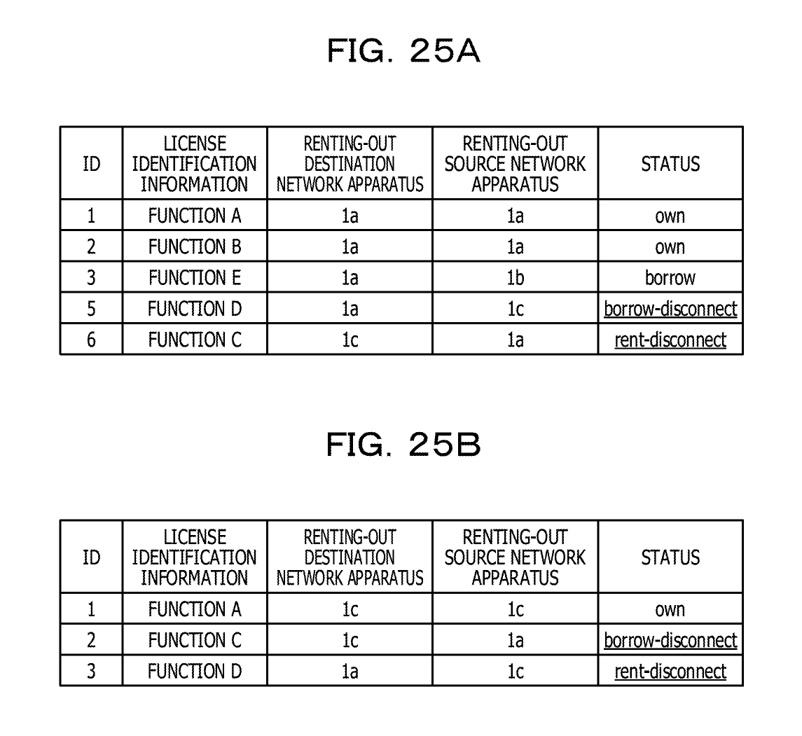

FIG. 25A and FIG. 25B are diagrams illustrating an example of the management information 131a and the management information 131c after the processing of S53 and S55 is executed from a state of the management information 131a and the management information 131c illustrated in FIG. 24A and FIG. 24B. FIG. 25A is an example of the management information 131a after the processing of S53 is executed and FIG. 25B is an example of the management information 131c after the processing of S55 is executed.

The “status” of information having the “ID” of “5” is updated with “borrow-disconnect” in the management information 131a illustrated in FIG. 25A (S55), compared with the management information 131a illustrated in FIG. 24A. The “status” of information having the “ID” of “6” is updated with “rent-disconnect” in the management information 131a illustrated in FIG. 25A (S53), compared with the management information 131a illustrated in FIG. 24A.

On the other hand, the “status” of information having the “ID” of “2” is updated with the “borrow-disconnect” in the management information 131c illustrated in FIG. 25B (S55), compared with the management information 131c illustrated in FIG. 24B. The “status” of information, of which the “ID” is “3”, is updated with “rent-disconnect” in the management information 131a illustrated in FIG. 25B (S53), compared with the management information 131c illustrated in FIG. 24B.

That is, in a case where the disconnected network apparatus (network apparatus 1c) of the network apparatuses included in the network apparatus group 10 is detected, the management information management unit 111a updates information about a license, which is in a renting-out and borrowing relationship with the disconnected network apparatus, of the management information 131a. In this case, the management information management unit 111c updates information about a license, which is in a renting-out and borrowing relationship with the disconnected network apparatus (network apparatus 1a), of the management information 131c.

Connection Detection Process

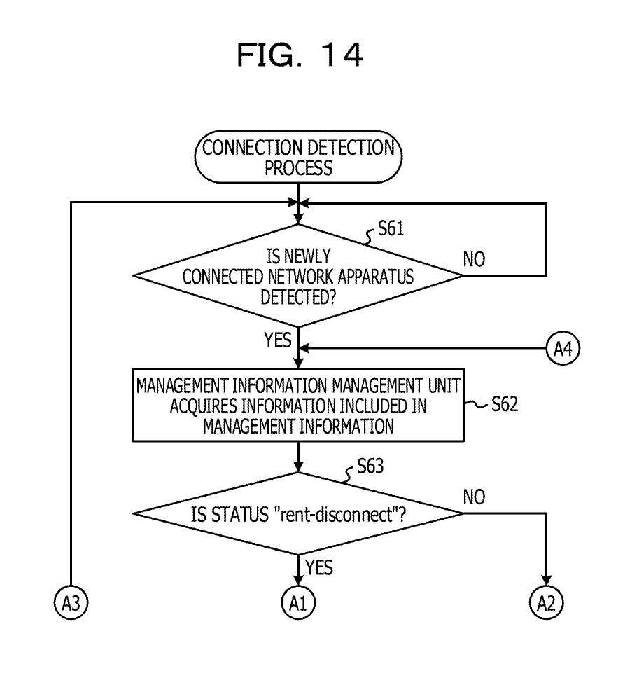

Next, description is made on a process (hereinafter, also simply referred to as a connection detection process), of the license management process, performed when connection between the network apparatus included in the network apparatus group 10 and a new network apparatus (including the network apparatus that was connected to the network apparatus group 10 in the past) is detected. FIG. 14 to FIG. 18 are flowcharts illustrating a connection detection process in the first embodiment. The connection detection process is executed in all the network apparatuses included in the network apparatus group 10. Hereinafter, description is made on a case where the network apparatus 1a executes a disconnection detection process. Also, hereinafter, description is made on the assumption that connection of the network apparatus 1a and the network apparatus 1c is resumed.

The connection state detection unit 112a, as illustrated in FIG. 14, waits until the network apparatus which is newly connected to the network apparatus group 10 is detected (NO in S61). In a case where a corresponding information management unit 113a of the network apparatus 1a detects the network apparatus (network apparatus 1c) which is newly connected to the network apparatus group 10 (YES in S61), the management information management unit 111a acquires information included in the management information 131a stored in the information storage area 130a (S62). For example, the management information management unit 111a acquires information for one record (for example, information corresponding to one row in the management information 131a described in FIG. 25A) of the management information 131a. The management information management unit 111a determines whether information, which is set in the “status” included in the information acquired in S62, is the “rent-disconnect” or not (S63).

That is, the network apparatus (network apparatus 1c) detected as newly connected in S61 may be the network apparatus which was connected to the network apparatus group 10 in the past. In this case, the network apparatus (network apparatus 1c) detected as newly connected may have performed the license renting out and borrowing with another network apparatus when the network apparatus was connected to the network apparatus group 10 in the past. Thus, in a case where when the connection with the new network apparatus (network apparatus 1c) is detected, the management information management unit 111a determines whether information about the new network apparatus is present in the management information 131a or not. With this, the management information management unit 111a is able to determine whether the new network apparatus (network apparatus 1c) is a network apparatus which was connected to the network apparatus included in the network apparatus group 10 in the past.

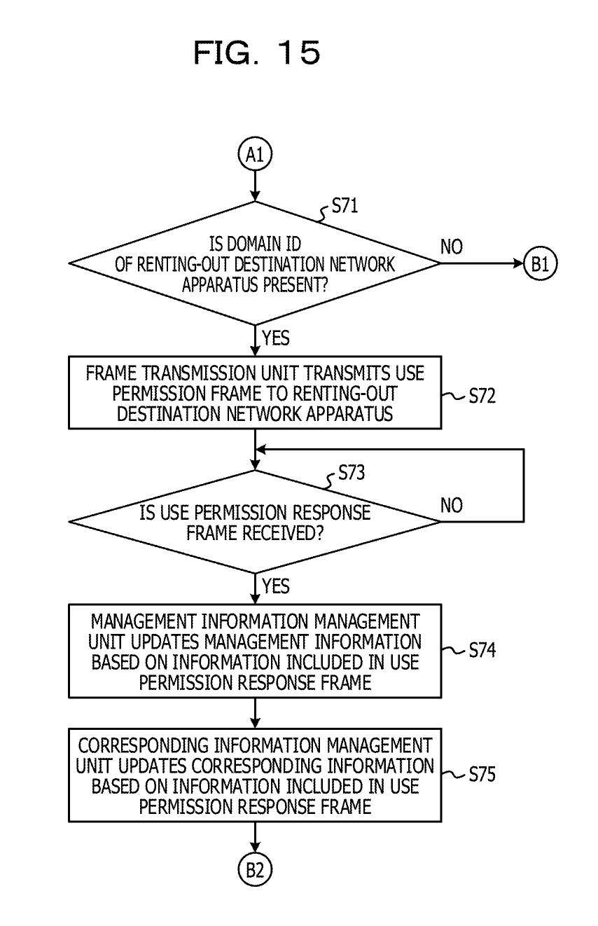

In a case where the “status” is the “rent-disconnect” (YES in S63), the management information management unit 111a, as illustrated in FIG. 15, determines whether the network apparatus including a domain ID, which is set in the “renting-out destination network apparatus” of the information acquired in S62, is present or not (S71). For example, the management information management unit 111a determines whether the network apparatus, which has a domain ID which is set in the “renting-out destination network apparatus” of the information acquired in S62, is included in the network apparatus group 10. As a result, in a case where the network apparatus including a domain ID, which is set in the “renting-out destination network apparatus” is present (YES in S71), the frame transmission unit 116a transmit a use permission frame to the network apparatus which is present (S72).

That is, in this case, the new network apparatus (network apparatus 1c) is the network apparatus which was connected to the network apparatus group 10 in the past or the network apparatus which took over the domain ID from the network apparatus which was connected to the network apparatus group 10 in the past due to apparatus exchange or the like. Accordingly, in this case, the management information management unit 111a determines that the new network apparatus (network apparatus 1c) is a network apparatus to which the license renting out may be permitted. The frame transmission unit 116a transmits the use permission frame for permitting the license renting out to the new network apparatus (network apparatus 1c) in S61.

In a case where the network apparatus 1c is the network apparatus which took over the domain ID from the network apparatus, which was connected to the network apparatus group 10 in the past, the network apparatus 1c is regarded as the network apparatus which has taken over the management information 131c from the network apparatus which was connected to the network apparatus group 10 in the past. Hereinafter, description is made on an example of the use permission frame.

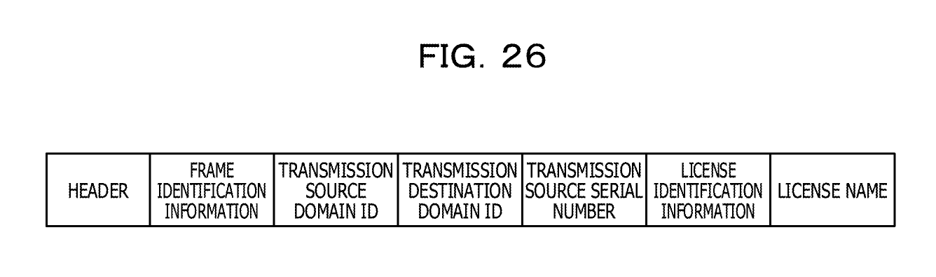

FIG. 26 is a diagram illustrating an example of a use permission frame. In the example illustrated in FIG. 26, the use permission frame includes, as information, a header of a frame, frame identification information identifying a type of the use permission frame, and a domain ID of the network apparatus (network apparatus 1a) of the frame transmission source. In the example illustrated in FIG. 26, the use permission frame includes, as information, a domain ID of the frame transmission destination network apparatus (network apparatus 1c) and a serial number allocated to the frame transmission source network apparatus (network apparatus 1a). In the example illustrated in FIG. 26, the use permission frame includes, as information, license identification information identifying a license of which use is permitted and a license name of the license of which use is permitted.

With this, the network apparatus 1a is able to permit the use of the license again, that was rented out in the past, to the network apparatus (network apparatus 1c) of which connection with the network apparatus 1a is disconnected in the network apparatuses to which the license was rented out in the past. The network apparatus 1a is able to permit the use of the license even in a case where the new network apparatus is the network apparatus which has taken over the domain ID from the network apparatus which was connected to the network apparatus group 10 in the past.

Referring back to FIG. 15, the frame reception unit 115a waits until the use permission response frame is received (NO in S73). The use permission response frame is a frame including information that indicates an execution state (execution result) of the processing executed by the license renting-out destination network apparatus (network apparatus 1c) based on the use permission response frame transmitted by the renting-out source network apparatus (network apparatus 1a) of the license. Information included in the use permission response frame is the same as information included in the renting-out response frame described in FIG. 20 and thus, description thereof is not repeated again.

In a case where the use permission response frame is received (YES in S73), the management information management unit 111a updates the management information 131a based on the information included in the received use permission response frame (S74). Description on an example of the processing of S74 is described later.

The corresponding information management unit 113a of the network apparatus 1a updates the corresponding information 132a based on the information included in the received use permission response frame (S75). The corresponding information 132a is information that manages serial numbers and domain IDs of respective network apparatuses included in the network apparatus group 10. The network apparatus 1a (frame transmission unit 116a) refers to, for example, information included in the corresponding information 132a to prepare various frames to be transmitted to other devices. Description on an example of processing of S75 is described later.

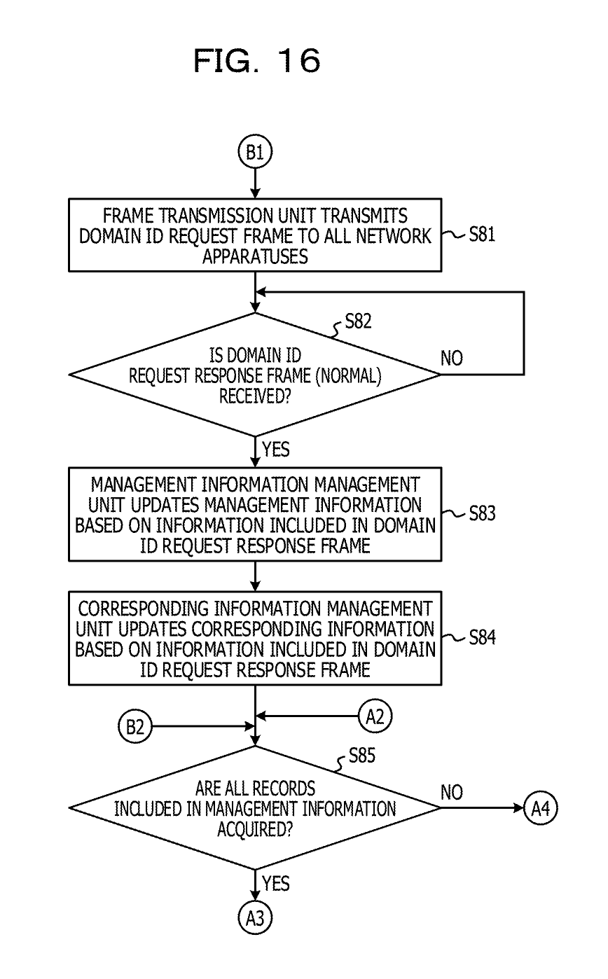

On the other hand, in a case where the network apparatus having the domain ID which is set in the “renting-out destination network apparatus ” of the information acquired in S62 of FIG. 14 is not present (YES in S71), the frame transmission unit 116a, as illustrated in FIG. 16, transmits a domain ID request frame to all the network apparatuses included in the network apparatus group 10 (S81).

That is, in this case, the new network apparatus may be the network apparatus to which the network apparatus 1a had rented out the license in the past, but of which the domain ID was changed in a period of time during which connection with the network apparatus 1a was disconnected. Accordingly, in this case, the network apparatus 1a (frame transmission unit 116a), as is described later, specifies the renting-out destination network apparatus of the license of which the “status” is determined as “rent-disconnect” in the processing of S63 of FIG. 14. The network apparatus 1a (frame transmission unit 116a) refers to the corresponding information 132a and transmits a domain ID request frame including the serial number of the specified renting-out destination network apparatus to all the network apparatuses included in the network apparatus group 10. With this, the network apparatus 1a, as is described later, is able to acquire the domain ID of the renting-out destination network apparatus of the license of which the “status” is determined as “rent-disconnect” in the processing of S63 of FIG. 14. Hereinafter, description is made on an example of the domain ID request frame.

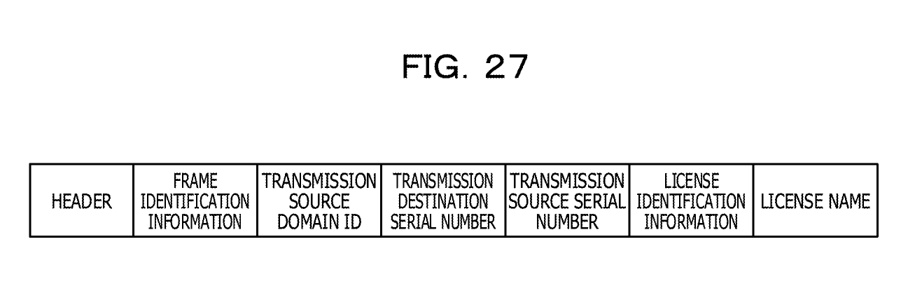

FIG. 27 is a diagram illustrating an example of a domain ID request frame. In the example illustrated in FIG. 27, the domain ID request frame includes, as information, a header of a frame, frame identification information identifying a type of the domain ID request frame, and a domain ID of the network apparatus (network apparatus 1a) of the frame transmission source. In the example illustrated in FIG. 27, the domain ID request frame includes, as information, a serial number allocated to the frame transmission destination network apparatus (each network apparatus included in the network apparatus group 10) and a serial number allocated to the frame transmission source network apparatus (network apparatus 1a). In the example illustrated in FIG. 27, the domain ID request frame includes, as information, license identification information identifying a license of which use is permitted and a license name of the license of which use is permitted as information.

The domain ID request frame illustrated in FIG. 27 is a frame for requesting the domain ID of the frame transmission destination and thus does not include the domain ID of the frame transmission destination included in the renting-out frame or the like. In the domain ID request frame illustrated in FIG. 27, the serial number of the transmission destination is included, instead of the transmission destination domain ID.

Referring back to FIG. 16, the frame reception unit 115a waits until the domain ID request response frame in which the “normal” is set in the “status” is received (NO in S82). That is, the frame reception unit 115a waits until the domain ID request response frame, in which the domain ID of the renting-out destination network apparatus of the license of which the “status” is determined as the “rent-disconnect”, is received in the processing of S63 of FIG. 14.

Thereafter, in a case where the domain ID request response frame in which the “normal” is set in the “status” is received (YES in S82), the management information management unit 111a updates the management information 131a (S83). For example, the management information management unit 111a updates the management information 131a based on information included in the received domain ID request response frame. With this, even when the new network apparatus is the network apparatus of which the domain ID was changed during disconnection in the network apparatus which was connected to the network apparatus group 10 in the past, the management information management unit 111a is able to reflect the changed domain ID into the management information 131a. In a case where the domain ID response frame in which the “abnormal” is set in the “status” is received, the management information management unit 111a does not update the management information 131a. An example of the processing of S83 is described later.

The corresponding information management unit 113a of the network apparatus 1a updates the corresponding information 132a based on information included in the received domain ID request response frame (S84). An example of the processing of S84 is described later.

Thereafter, the management information management unit 111a determines whether all the pieces of information included in the management information 131a are acquired in the processing of S62 of FIG. 14 or not (S85). As a result, in a case where it is determined that all the pieces of information included in the management information 131a are acquired (YES in S85), the management information management unit 111a waits until the newly connected network apparatus is detected again (NO in S61 of FIG. 14). On the other hand, in a case where it is determined that all the pieces of information included in the management information 131a are not acquired (NO in S85), the management information management unit 111a repeatedly executes the process continuing after the processing of S63.

Even in a case where the processing of S75 of FIG. 15 is completed, or in a case where the “status” of information acquired in the S62 of FIG. 14 is not the “rent-disconnect” (NO in S63 of FIG. 14), the management information management unit 111a executes the processing of S84.

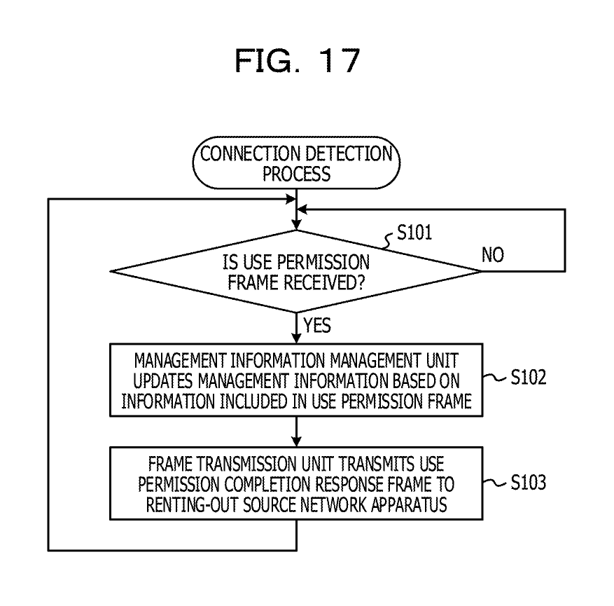

Next, description is made on the process performed by the network apparatus which has received the use permission frame. FIG. 17 is a flowchart illustrating a process performed by the network apparatus which has received the use permission frame. Hereinafter, description is made on a case where the network apparatus 1c receives the use permission frame from the network apparatus 1a.

The frame reception unit 115c of the network apparatus 1c, as illustrated in FIG. 17, waits until the use permission frame is received (NO in S101). In a case where the use permission frame is received (YES in S101), the management information management unit 111c updates the management information 131c based on information included in the received use permission frame (S102). An example of the processing of S102 is described later.

The frame transmission unit 116c transmits a use permission completion response frame including information that the processing of S102 is completed to the network apparatus (network apparatus 1a) of a use permission request frame transmission source (S103).

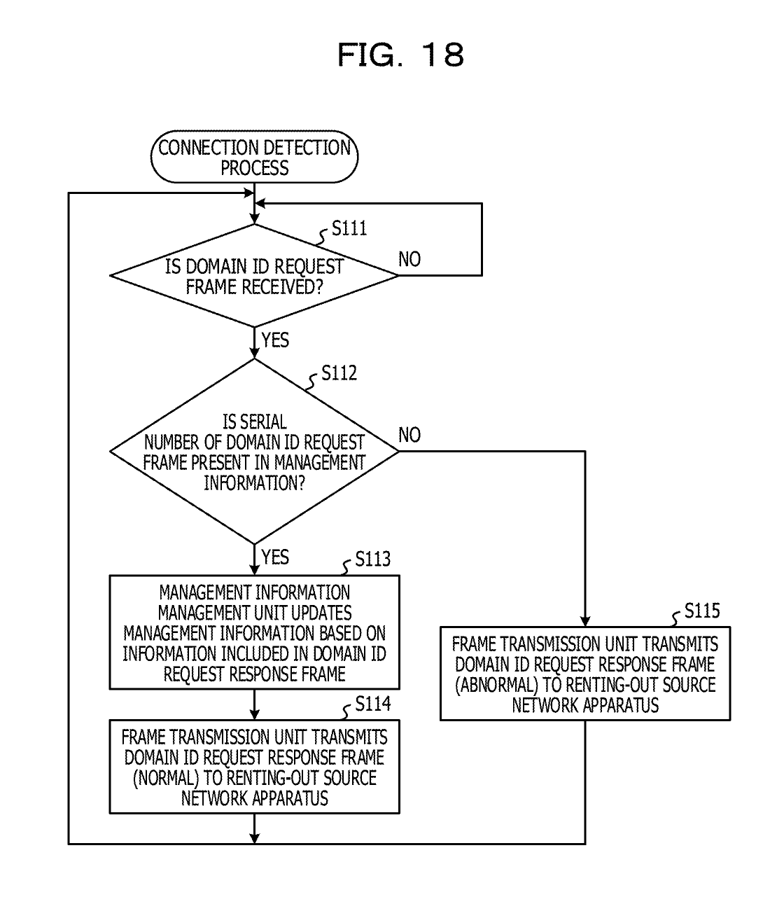

Next, description is made on the process performed by the network apparatus which has received the domain ID request frame. FIG. 18 is a flowchart illustrating a process performed by the network apparatus which has received the domain ID request frame. Hereinafter, description is made on the assumption that the network apparatus 1c receives the domain ID request frame from the network apparatus 1a.

The frame reception unit 115c of the network apparatus 1c, as illustrated in FIG. 18, waits until the domain ID request frame is received (NO in 5111). In a case where the domain ID request frame is received (YES in 5111), the management information management unit 111c determines whether the serial number included in the domain ID request frame is included in the management information 131c or not (S112).

That is, in S81 of FIG. 16, the network apparatus 1a transmits the domain ID request frame to all the network apparatuses included in the network apparatus group 10. Thus, a network apparatus, of which a serial number included in domain ID request frame is not included in the management information 131c, is present in the network apparatuses which have received domain ID request frame. Accordingly, the management information management unit 111c, in the processing of S102, determines whether the device itself is the network apparatus which borrowed the license from the network apparatus 1a in the past.

As a result, in a case where the serial number is included in the management information 131c (YES in S112), the management information management unit 111c updates the management information 131c based on information included in the domain ID request frame (S113). An example of the processing of S113 is described later. The frame transmission unit 116c transmits the domain ID response frame in which the “normal” is set in the “status” to the transmission source network apparatus (network apparatus 1a) of the domain ID request frame (S114).

On the other hand, in a case where the serial number is not included in the management information 131c (NO in S112), the frame transmission unit 116c transmits the domain ID response frame in which the “abnormal” is set in the “status” to the transmission source network apparatus (network apparatus 1a) of the domain ID request frame (S115).

Example of Processing of S75 and S102 (Processing of S83 and S113)

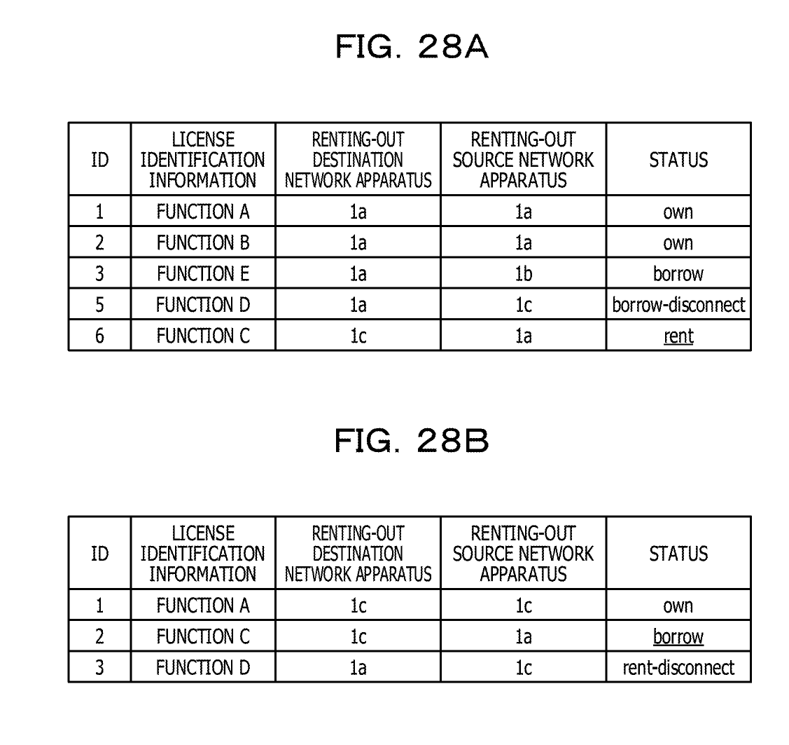

Next, description is made on an example of the processing of S75 and S102 (processing of S83 and S113). FIG. 28A and FIG. 28B are diagrams illustrating an example of management information 131a and management information 131c after processing of S75 and S102 (processing of S83 and S113) is executed from a state indicated by the management information 131a and the management information 131c illustrated in FIG. 25A and FIG. 25B. FIG. 28A is an example of the management information 131a after the processing of S75 (processing of S83) is executed and FIG. 28B is an example of the management information 131c after the processing of S102 (processing of S113) is executed. The updated contents of the management information 131a and the management information 131c due to the processing of S75 and S102 are the same contents as those of the management information 131a and the management information 131c due to the processing of S83 and S113.

The “status” of information having the “ID” of “6” is updated with the “rent” in the management information 131a illustrated in FIG. 28A, compared with the management information 131a illustrated in the FIG. 25A (S74 and S83). On the other hand, the “status” of information having the “ID” of “2” is updated with the “borrow” in the management information 131c illustrated in FIG. 28B, compared with the management information 131c illustrated in the FIG. 25A (S102 and S113).

That is, even in a case where connection to the network, with which the license renting out and borrowing is performed, is disconnected, the management information management unit 111a maintains information regarding the renting-out and borrowing relationship with the disconnected network apparatus in the management information 131a. Accordingly, in a case where the new network apparatus (network apparatus 1c) is the network apparatus which was connected to the network apparatus 1a in the past, the network apparatus 1a and the new network apparatus (network apparatus 1c) do not desire to execute again the processing for performing the license renting out and borrowing.

Even in a case where the new network apparatus (network apparatus 1c) is the network apparatus of which the serial number is changed from the network apparatus to which the network apparatus 1a was connected in the past, the network apparatus 1a does not desire to execute again the processing for performing the license renting out and borrowing.

Even in a case where the new network apparatus (network apparatus 1c) is the network apparatus of which the domain ID was changed from the network apparatus to which the network apparatus 1a was connected in the past, the network apparatus 1a does not desire to execute again the processing for performing the license renting out and borrowing.

Example of Processing of S75

Next, description is made on an example of the processing of S75.

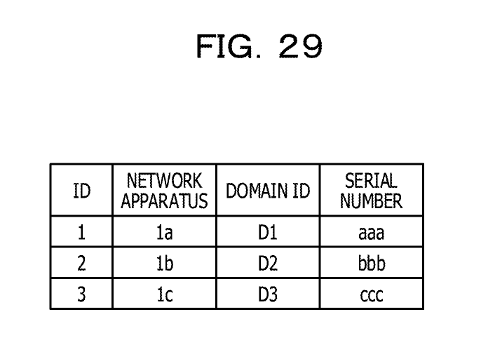

FIG. 29 is a diagram illustrating an example of corresponding information 132a before the processing of S75 is executed. The corresponding information 132a illustrated in FIG. 29 includes, as items, the “ID” identifying respective pieces of information included in the corresponding information 132a and the “network apparatus” identifying each network apparatus included in the network apparatus group 10 as items. The corresponding information 132a illustrated in FIG. 29 includes, as items, the “domain ID ” which is a domain ID of the corresponding network apparatus and the “serial number” which is a serial number of the corresponding network apparatus.

For example, “1a” is set as the “network apparatus”, “D1” is set as the “domain ID”, and the “aaa” is set as the “serial number” in information having the “ID” of “1” of the corresponding information 132a illustrated in FIG. 29. Description on other pieces of information included in FIG. 29 is not repeated again.

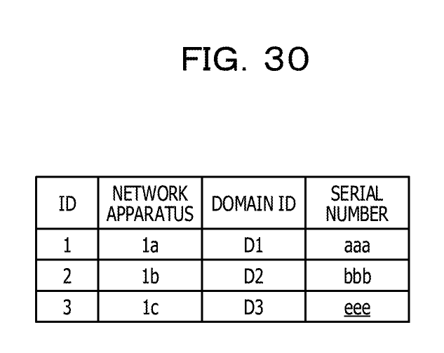

FIG. 30 is a diagram illustrating an example of the corresponding information 132a after the processing of S75 is executed. The information which is set in the “serial number” of information having the “ID” of “3” is updated with the “eee” (underlined portion of FIG. 30) in the corresponding information 132a illustrated in FIG. 30, compared with the corresponding information 132a illustrated in FIG. 29.

That is, in a case where the connection state detection unit 112a detects the newly connected network apparatus, the corresponding information management unit 113a updates the corresponding information 132a stored in the information storage area 130a. With this, the network apparatus 1a is able to maintain the corresponding information 132a in which the current states of the respective network apparatuses included in the network apparatus group 10 are reflected. Thus, the network apparatus 1a (frame transmission unit 116a) is able to prepare respective frames based on, for example, the corresponding information 132a in which the current states of the respective network apparatuses are reflected.

In a case where a new network apparatus, which was not connected to the network apparatus group 10 in the past, is connected to the network apparatus group 10, information on the new network apparatus is not present in the corresponding information 132a. Therefore, in this case, the manager may add information about the new network apparatus to the corresponding information 132a.

Example of Processing of S84

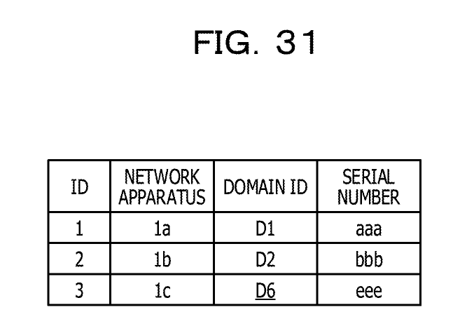

FIG. 31 is a diagram illustrating an example of corresponding information 132a after processing of S84 is executed from the state of the corresponding information 132a illustrated in FIG. 30. For example, the “domain ID” of the information having the “ID” of “3” is updated with “D6” (underlined portion of FIG. 31) in the corresponding information 132a illustrated in FIG. 31, compared with the corresponding information 132a as illustrated in FIG. 27. With this, the network apparatus 1a is able to maintain the corresponding information 132a in which the current states of respective network apparatuses included in the network apparatus group 10 are reflected.

Details of Processing of S63

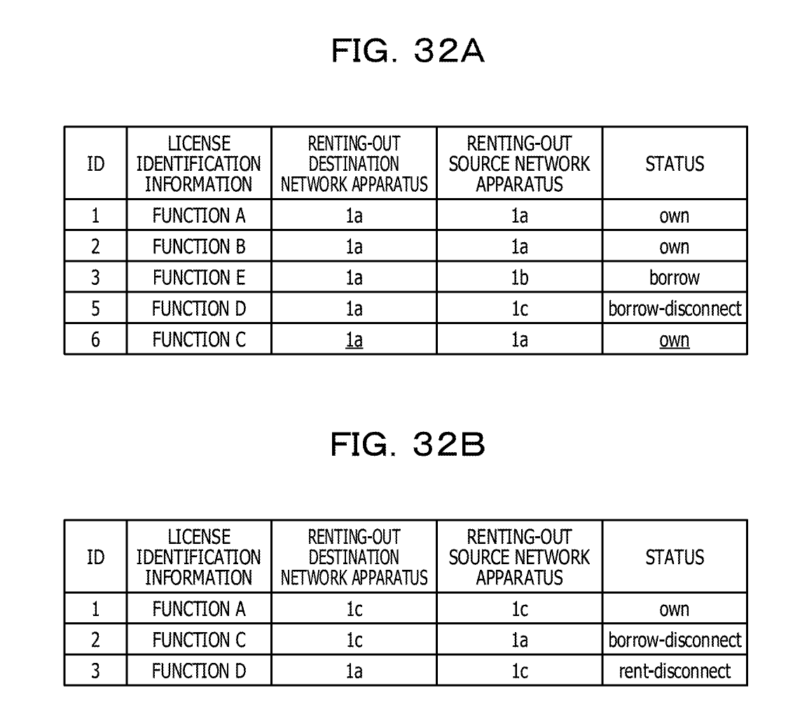

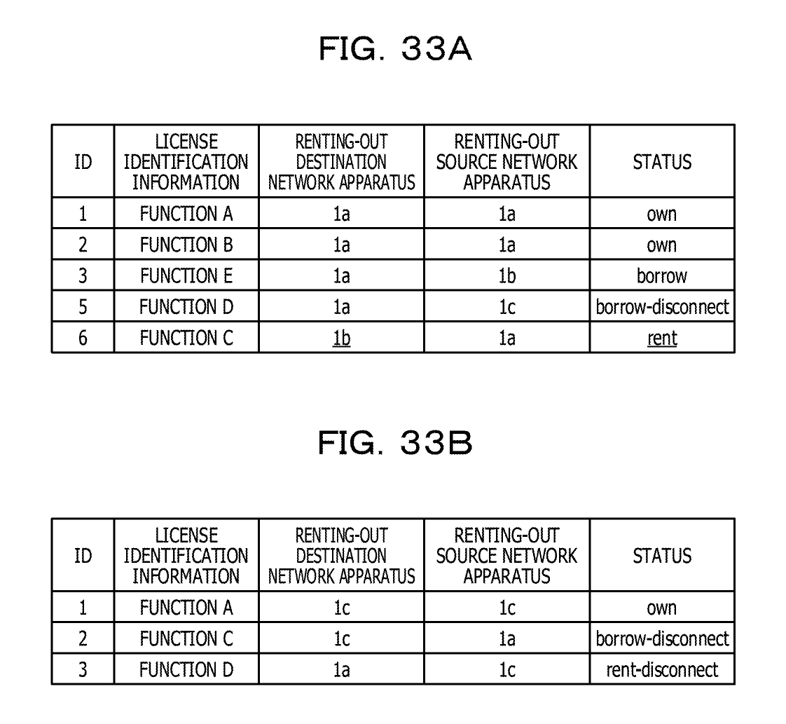

Next, description is made on details of the processing of S63 in FIG. 14. FIG. 32A, FIG. 32B, FIG. 33A, and FIG. 33B are diagrams illustrating details of the processing of S63. For example, FIG. 32A is a diagram for illustrating the management information 131a in a case where the network apparatus 1a has dissolved the relationship between the renting out and the borrowing of the license and FIG. 32B is a diagram for illustrating the management information 131c in a case where the network apparatus 1c has dissolved the relationship between the renting out and the borrowing of the license. FIG. 33A is a diagram for illustrating the management information 131a in a case where the network apparatus 1a has new license renting out and FIG. 33B is a diagram for illustrating the management information 131c in a case where the network apparatus 1c has performed new license renting out.

In an example illustrated in FIG. 25A and FIG. 25B, the network apparatus 1a has rented out the license included in the management information 131a and having the “ID” of “6” to the network apparatus 1c. In this state, in a case where the connection of the network apparatus 1a and the network apparatus 1c is disconnected, the network apparatus 1a, as illustrated in FIG. 32A, may dissolve the relationship between the renting out and the borrowing of the license regarding the license (license having the “ID” of “6” and included in management information 131a) which is rented out to the network apparatus 1c.

For example, the “renting-out destination network apparatus” and the “status” of information having the “ID” is “6” are updated with “1a” and the “own”, respectively, in the management information 131a illustrated in FIG. 32A, compared with the management information 131a illustrated in FIG. 25A. On the other hand, connection of the network apparatus 1a and the network apparatus 1c is disconnected and thus, any piece of information is not updated in the management information 131c illustrated in FIG. 32B, compared with the management information 131c illustrated in FIG. 25B.

In this case, the network apparatus 1a, as illustrated in FIG. 33A, may rent out the license (license having “ID” of “6” and included in management information 131a) of which the license renting-out and the borrowing relationship is dissolved, to another network apparatus (for example, network apparatus 1b).

For example, the “renting-out destination network apparatus” and the “status” of information having the “ID” of “6” is updated with “1b” and the “rent”, respectively, in the management information 131a illustrated in FIG. 33A, compared with the management information 131a illustrated in FIG. 25A. In this case, connection of the network apparatus 1a and the network apparatus 1c is also disconnected and thus, any piece of information is not updated in the management information 131c illustrated in FIG. 32B, compared with the management information 131c illustrated in FIG. 25B.

Even in a case where the connection of the network apparatus 1a and the network apparatus 1c is resumed after the state illustrated in FIG. 33A and FIG. 33B, the network apparatus 1a does not rent out the license, which is included in the management information 131a and has the “ID” of “6”, to the network apparatus 1c.

That is, the “1b” is set in the “renting-out destination network apparatus” of the information included in the management information 131a and having the “ID” of “6” as illustrated in FIG. 33A. The “rent” is set in the “status” of the information included in the management information 131a and having the “ID” of “6” as illustrated in FIG. 33A. Thus, the network apparatus 1a does not transmit the use permission frame to the network apparatus 1c (NO in S63 of FIG. 14).

With this, even in a case where the license being rented out is rented out to another network apparatus in a time period during which connection to the network apparatus, with which the license renting out and borrowing is maintained, is disconnected, the network apparatus 1a is able to avoid the same license being rented out to a plurality of network apparatuses.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A management device that manages permitting a first device to use a license, the management device comprising:
a memory configured to store management information including information regarding a license of which renting out and borrowing is performed between the first device and a second device included in a plurality of connection destination devices coupled to the first device through a network and information regarding the license for the first device; and
a processor configured to update the management information based on connection information for the second device when the connection state of the second device is changed.

2. The management device according to claim 1, wherein
in a case where the first device borrows a first license from the second device, the processor adds first borrowing information indicating the first device being permitted to use the first license to the management information stored in the memory, and
in a case where the first borrowing information is included in the management information and disconnection of the first device from the second device is detected, the processor adds second borrowing information indicating the first device being not permitted to use the first license to the management information stored in the memory, instead of the first borrowing information.

3. The management device according to claim 1, wherein
in a case where the first device rents out a second license to the second device, the processor adds first renting-out information indicating the first device being not permitted to use the second license to the management information stored in the memory, and
in a case where the first renting-out information is included in the management information and disconnection of the first device from the second device is detected, the processor adds second renting-out information indicating the second device being not permitted to use the second license to the management information stored in the memory, instead of the first renting-out information.

4. The management device according to claim 2,
wherein the processor updates the management information stored in the memory so as not to include the first borrowing information or the second borrowing information in a case where the first borrowing information or the second borrowing information is included in the management information and the first license is returned from the first device to the second device.

5. The management device according to claim 3,
wherein the processor updates the management information stored in the memory so as not to include the first renting-out information or the second renting-out information in a case where the first renting-out information or the second renting-out information is included in the management information and the second license is returned from the second device to the first device.

6. The management device according to claim 2,
wherein the processor stores the first borrowing information in the memory as part of the management information instead of the second borrowing information in a case where resumption of connection between the first device and the second device is detected after the disconnection of the first device from the second device is detected.

7. The management device according to claim 3,
wherein the processor stores the first renting-out information in the memory as part of the management information instead of the second renting-out information in a case where resumption of connection between the first device and the second device is detected after the disconnection of the first device from the second device is detected.

8. The management device according to claim 6, wherein
first identification information and second identification information are allocated to each device included in the plurality of devices for identifying the device among the plurality of devices, and
the processor identifies each device included in the plurality of devices based on the first identification information and the second identification information when the change in the connection state is detected, and
in a case where connection of a device, to which any one of the first identification information and second identification information is allocated, and the first device is detected after the disconnection of the first device from the second device is detected, the processor determines the device detected as being coupled to the first device to be the second device.

9. The management device according to claim 1,
wherein each device included in the plurality of devices is a fiber channel switch.

10. A management method that manages permitting a first device to use a license, the management method comprising:
storing management information including information regarding a license of which renting out and borrowing is performed between the first device and a second device included in a plurality of connection destination devices coupled to the first device through a network and information regarding the license for the first device; and
updating the management information based on connection information for the second device when the connection state of the second device is changed.
